(19) United States
(12) Patent Application Publication
(10) Pub. No.: US 2024/0259687 A1
(43) Pub. Date: Aug. 1, 2024

(54) INTEGRATION OF HARDWARE AND SOFTWARE TRACKING USER INTERFACES

(71) Applicant: Apple Inc., Cupertino, CA (US)

(72) Inventors: Onur E. TACKIN, Saratoga, CA (US); Mahmut DEMIR, Pleasanton, CA (US); Johnnie B. MANZARI, San Francisco, CA (US); Samuel D. POST, Great Falls, MT (US); Dhruv SAMANT, Mountain View, CA (US)

(21) Appl. No.: 18/523,076

(22) Filed: Nov. 29, 2023

Related U.S. Application Data
(60) Provisional application No. 63/445,871, filed on Feb. 15, 2023.
(60) Provisional application No. 63/439,560, filed on Jan. 17, 2023.

(51) Int. Cl. H04N 23/695; G06F 3/01; G06T 7/20; H04N 23/611

(52) U.S. Cl. CPC H04N 23/695; G06F 3/013; G06T 7/20; H04N 23/611

(57) ABSTRACT

The present disclosure generally relates to capturing video using a moveable mount.

### CROSS-REFERENCE TO RELATED APPLICATIONS

This application claims priority from U.S. Provisional Patent Application Ser. No. 63/439,560, entitled “INTEGRATION OF HARDWARE AND SOFTWARE TRACKING USER INTERFACES,” filed Jan. 17, 2023, and U.S. Provisional Patent Application Ser. No. 63/445,871, entitled “INTEGRATION OF HARDWARE AND SOFTWARE TRACKING USER INTERFACES”, filed Feb. 15, 2023, the contents of each of which are hereby incorporated by reference in their entirety.

### FIELD

The present disclosure relates generally to computer user interfaces, and more specifically to techniques for integrating hardware and software tracking user interfaces.

### BACKGROUND

Electronic devices can be used to capture images and/or video. The captured images and/or video can be used to track one or more subjects.

### BRIEF SUMMARY

Some techniques for integrating hardware and software tracking user interfaces using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for integrating hardware and software tracking user interfaces. Such methods and interfaces optionally complement or replace other methods for integrating hardware and software tracking user interfaces. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system that is in communication with two or more camera sensors and one or more input devices: detecting, via the one or more input devices, a request to capture video using a field of view of one or more camera sensors that changes based on movement of one or more subjects within the field of view of the one or more camera sensors; in response to detecting the request to capture video: in accordance with a determination that the computer system is connected to a moveable mount, initiating a process for capturing video with a first camera sensor of the two or more camera sensors; and in accordance with a determination that the computer system is not connected to the moveable mount, initiating a process for capturing video with a second camera sensor of the two or more camera sensors that is different from the first camera sensor.

In accordance with some embodiments, a non-transitory computer-readable storage medium is described. The non-transitory computer-readable storage medium stores one or more programs configured to be executed by one or more processors of a computer system that is in communication with two or more camera sensors and one or more input devices, the one or more programs including instructions for: detecting, via the one or more input devices, a request to capture video using a field of view of one or more camera sensors that changes based on movement of one or more subjects within the field of view of the one or more camera sensors; in response to detecting the request to capture video: in accordance with a determination that the computer system is connected to a moveable mount, initiating a process for capturing video with a first camera sensor of the two or more camera sensors; and in accordance with a determination that the computer system is not connected to the moveable mount, initiating a process for capturing video with a second camera sensor of the two or more camera sensors that is different from the first camera sensor.

In accordance with some embodiments, a transitory computer-readable storage medium is described. The transitory computer-readable storage medium stores one or more programs configured to be executed by one or more processors of a computer system that is in communication with two or more camera sensors and one or more input devices, the one or more programs including instructions for: detecting, via the one or more input devices, a request to capture video using a field of view of one or more camera sensors that changes based on movement of one or more subjects within the field of view of the one or more camera sensors; in response to detecting the request to capture video: in accordance with a determination that the computer system is connected to a moveable mount, initiating a process for capturing video with a first camera sensor of the two or more camera sensors; and in accordance with a determination that the computer system is not connected to the moveable mount, initiating a process for capturing video with a second camera sensor of the two or more camera sensors that is different from the first camera sensor.

In some embodiments, a computer system configured to communicate with two or more camera sensors and one or more input devices is described. The computer system comprises: one or more processors; and memory storing one or more programs configured to be executed by the one or more processors, the one or more programs including instructions for: detecting, via the one or more input devices, a request to capture video using a field of view of one or more camera sensors that changes based on movement of one or more subjects within the field of view of the one or more camera sensors; in response to detecting the request to capture video: in accordance with a determination that the computer system is connected to a moveable mount, initiating a process for capturing video with a first camera sensor of the two or more camera sensors; and in accordance with a determination that the computer system is not connected to the moveable mount, initiating a process for capturing video with a second camera sensor of the two or more camera sensors that is different from the first camera sensor.

In some embodiments, a computer system configured to communicate with two or more camera sensors and one or more input devices is described. The computer system comprises: means for detecting, via the one or more input devices, a request to capture video using a field of view of one or more camera sensors that changes based on movement of one or more subjects within the field of view of the one or more camera sensors; means for, in response to detecting the request to capture video: in accordance with a determination that the computer system is connected to a moveable mount, initiating a process for capturing video with a first camera sensor of the two or more camera sensors; and in accordance with a determination that the computer system is not connected to the moveable mount, initiating a process for capturing video with a second camera sensor of the two or more camera sensors that is different from the first camera sensor.

In accordance with some embodiments, a computer program product is described. The computer program product comprises one or more programs configured to be executed by one or more processors of a computer system that is in communication with two or more camera sensors and one or more input devices, the one or more programs including instructions for: detecting, via the one or more input devices, a request to capture video using a field of view of one or more camera sensors that changes based on movement of one or more subjects within the field of view of the one or more camera sensors; in response to detecting the request to capture video: in accordance with a determination that the computer system is connected to a moveable mount, initiating a process for capturing video with a first camera sensor of the two or more camera sensors; and in accordance with a determination that the computer system is not connected to the moveable mount, initiating a process for capturing video with a second camera sensor of the two or more camera sensors that is different from the first camera sensor.

In accordance with some embodiments, a method is described. The method comprises: at a computer system that includes one or more camera sensors: detecting a request to capture video with the one or more camera sensors of the computer system; and in response to detecting the request to capture the video: in accordance with a determination that the computer system is connected to a moveable mount, initiating a process to capture video with the one or more camera sensors of the computer system according to a respective subject tracking mode of operation; and in accordance with a determination that the computer system is not connected to a moveable mount, initiating a process to capture video with the one or more camera sensors without enabling the respective subject tracking mode of operation.

In accordance with some embodiments, a non-transitory computer-readable storage medium is described. The non-transitory computer-readable storage medium stores one or more programs configured to be executed by one or more processors of a computer system that is in communication with one or more camera sensors, the one or more programs including instructions for: detecting a request to capture video with the one or more camera sensors of the computer system; and in response to detecting the request to capture the video: in accordance with a determination that the computer system is connected to a moveable mount, initiating a process to capture video with the one or more camera sensors of the computer system according to a respective subject tracking mode of operation; and in accordance with a determination that the computer system is not connected to a moveable mount, initiating a process to capture video with the one or more camera sensors without enabling the respective subject tracking mode of operation.

In accordance with some embodiments, a transitory computer-readable storage medium is described. The transitory computer-readable storage medium stores one or more programs configured to be executed by one or more processors of a computer system that is in communication with one or more camera sensors, the one or more programs including instructions for: detecting a request to capture video with the one or more camera sensors of the computer system; and in response to detecting the request to capture the video: in accordance with a determination that the computer system is connected to a moveable mount, initiating a process to capture video with the one or more camera sensors of the computer system according to a respective subject tracking mode of operation; and in accordance with a determination that the computer system is not connected to a moveable mount, initiating a process to capture video with the one or more camera sensors without enabling the respective subject tracking mode of operation.

In accordance with some embodiments, a computer system configured to communicate with one or more camera sensors is described. The computer system comprises: one or more processors; and memory storing one or more programs configured to be executed by the one or more processors, the one or more programs including instructions for: detecting a request to capture video with the one or more camera sensors of the computer system; and in response to detecting the request to capture the video: in accordance with a determination that the computer system is connected to a moveable mount, initiating a process to capture video with the one or more camera sensors of the computer system according to a respective subject tracking mode of operation; and in accordance with a determination that the computer system is not connected to a moveable mount, initiating a process to capture video with the one or more camera sensors without enabling the respective subject tracking mode of operation.

In accordance with some embodiments, a computer system configured to communicate with one or more camera sensors is described. The computer system comprises: means for detecting a request to capture video with the one or more camera sensors of the computer system; and means for, in response to detecting the request to capture the video: in accordance with a determination that the computer system is connected to a moveable mount, initiating a process to capture video with the one or more camera sensors of the computer system according to a respective subject tracking mode of operation; and in accordance with a determination that the computer system is not connected to a moveable mount, initiating a process to capture video with the one or more camera sensors without enabling the respective subject tracking mode of operation.

In accordance with some embodiments, a computer program product is described. The computer program product comprises one or more programs configured to be executed by one or more processors of a computer system that is in communication with one or more camera sensors, the one or more programs including instructions for: detecting a request to capture video with the one or more camera sensors of the computer system; and in response to detecting the request to capture the video: in accordance with a determination that the computer system is connected to a moveable mount, initiating a process to capture video with the one or more camera sensors of the computer system according to a respective subject tracking mode of operation; and in accordance with a determination that the computer system is not connected to a moveable mount, initiating a process to capture video with the one or more camera sensors without enabling the respective subject tracking mode of operation.

In accordance with some embodiments, a method is described. The method comprises: at a computer system that is in communication with a moveable mount: obtaining an indication of an event associated with capturing video, wherein the video is captured by a device that is connected to the moveable mount, and wherein the device that is connected to the moveable mount is moved, via the moveable mount, to track one or more objects while the video is being captured; and in response to obtaining the indication of the event, causing the moveable mount to perform a sequence of one or more mechanical movements that move the device that is connected to the moveable mount, wherein the sequence of one or more mechanical movements is associated with the event.

In accordance with some embodiments, a non-transitory computer-readable storage medium is described. The non-transitory computer-readable storage medium stores one or more programs configured to be executed by one or more processors of a computer system that is in communication with a moveable mount, the one or more programs including instructions for: obtaining an indication of an event associated with capturing video, wherein the video is captured by a device that is connected to the moveable mount, and wherein the device that is connected to the moveable mount is moved, via the moveable mount, to track one or more objects while the video is being captured; and in response to obtaining the indication of the event, causing the moveable mount to perform a sequence of one or more mechanical movements that move the device that is connected to the moveable mount, wherein the sequence of one or more mechanical movements is associated with the event.

In accordance with some embodiments, a transitory computer-readable storage medium is described. The transitory computer-readable storage medium stores one or more programs configured to be executed by one or more processors of a computer system that is in communication with a moveable mount, the one or more programs including instructions for: obtaining an indication of an event associated with capturing video, wherein the video is captured by a device that is connected to the moveable mount, and wherein the device that is connected to the moveable mount is moved, via the moveable mount, to track one or more objects while the video is being captured; and in response to obtaining the indication of the event, causing the moveable mount to perform a sequence of one or more mechanical movements that move the device that is connected to the moveable mount, wherein the sequence of one or more mechanical movements is associated with the event.

In accordance with some embodiments, a computer system configured to communicate with a moveable mount is described. The computer system comprises: one or more processors; and memory storing one or more programs configured to be executed by the one or more processors, the one or more programs including instructions for: obtaining an indication of an event associated with capturing video, wherein the video is captured by a device that is connected to the moveable mount, and wherein the device that is connected to the moveable mount is moved, via the moveable mount, to track one or more objects while the video is being captured; and in response to obtaining the indication of the event, causing the moveable mount to perform a sequence of one or more mechanical movements that move the device that is connected to the moveable mount, wherein the sequence of one or more mechanical movements is associated with the event.

In accordance with some embodiments, a computer system configured to communicate with a moveable mount is described. The computer system comprises: means for obtaining an indication of an event associated with capturing video, wherein the video is captured by a device that is connected to the moveable mount, and wherein the device that is connected to the moveable mount is moved, via the moveable mount, to track one or more objects while the video is being captured; and means for, in response to obtaining the indication of the event, causing the moveable mount to perform a sequence of one or more mechanical movements that move the device that is connected to the moveable mount, wherein the sequence of one or more mechanical movements is associated with the event.

In accordance with some embodiments, a computer program product is described. The computer program product comprises one or more programs configured to be executed by one or more processors of a computer system that is in communication with a moveable mount, the one or more programs including instructions for: obtaining an indication of an event associated with capturing video, wherein the video is captured by a device that is connected to the moveable mount, and wherein the device that is connected to the moveable mount is moved, via the moveable mount, to track one or more objects while the video is being captured; and in response to obtaining the indication of the event, causing the moveable mount to perform a sequence of one or more mechanical movements that move the device that is connected to the moveable mount, wherein the sequence of one or more mechanical movements is associated with the event.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for integrating hardware and software tracking user interfaces, thereby increasing the effectiveness, efficiency, and user satisfaction with such devices. Such methods and interfaces may complement or replace other methods for integrating hardware and software tracking user interfaces.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6I illustrate exemplary user interfaces for capturing video in accordance with some embodiments.

FIG. 7 is a flow diagram illustrating methods for capturing video in accordance with some embodiments.

FIG. 8A-8P illustrate exemplary user interfaces for capturing video in accordance with some embodiments.

FIG. 9 is a flow diagram illustrating methods for capturing video in accordance with some embodiments.

FIGS. 10A-10H illustrate exemplary techniques for performing animations with a moveable mount in accordance with some embodiments.

FIG. 11 is a flow diagram illustrating methods for performing animations with a moveable mount in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for integrating hardware and software tracking user interfaces. In some embodiments, a computer system selects a camera for capturing video based on whether the computer system is connected to a moveable mount. In some embodiments, a computer system enables a respective subject tracking mode of operation based on whether the computer system is connected to a moveable mount. In some embodiments, a computer system causes a moveable mount to perform a sequence of one or more mechanical movements that move a device that is connected to the moveable mount. Such techniques can reduce the cognitive burden on a user who uses integrated hardware and software tracking user interfaces, thereby enhancing productivity. Further, such techniques can reduce processor and battery power otherwise wasted on redundant user inputs.

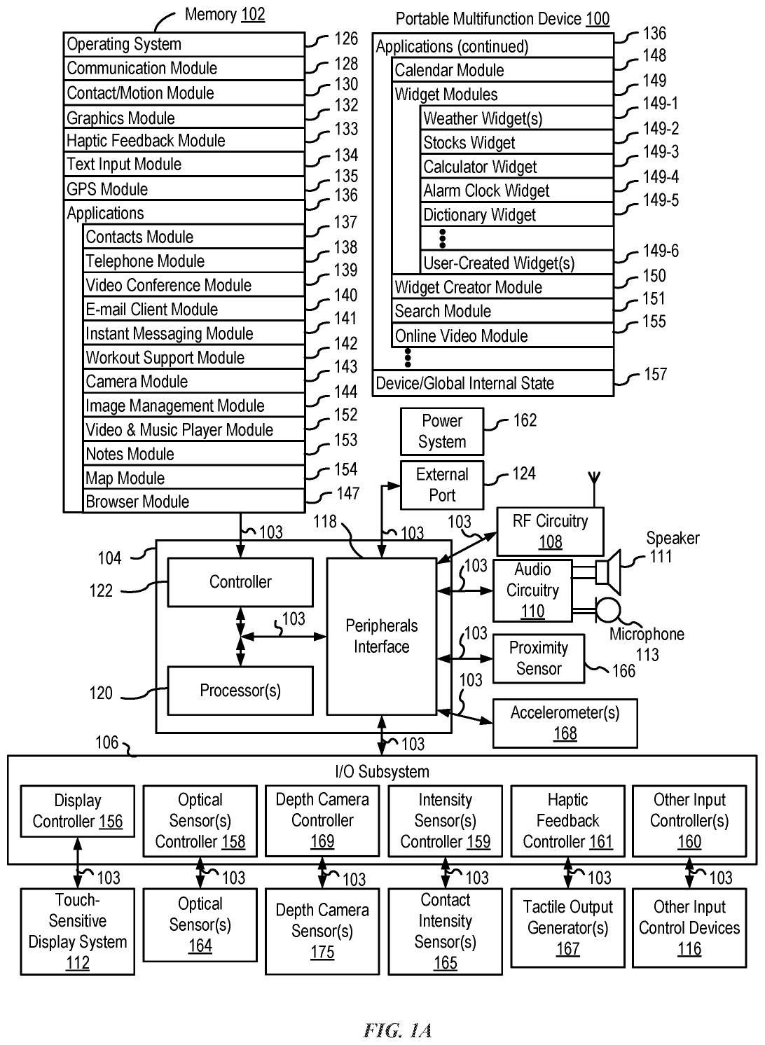

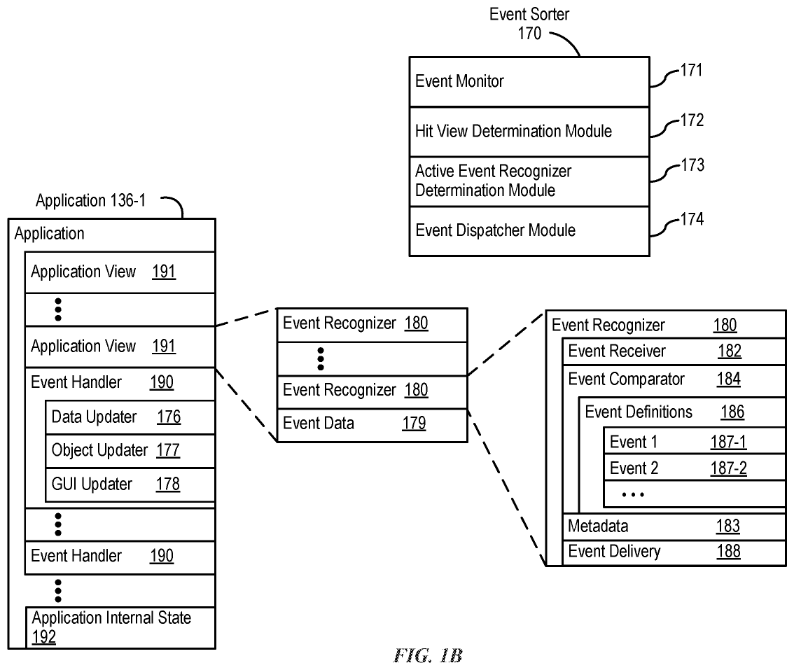

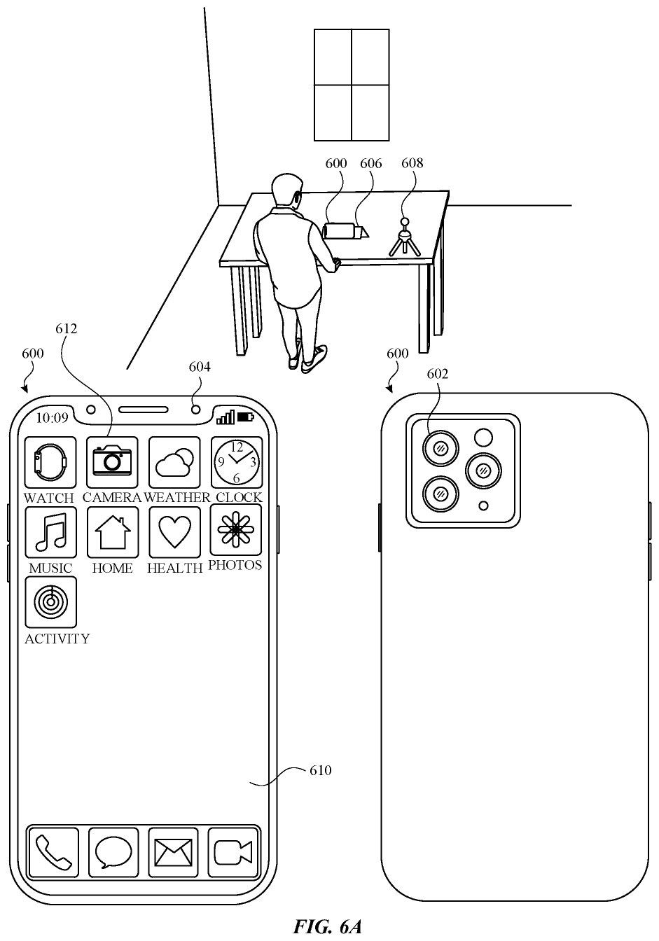

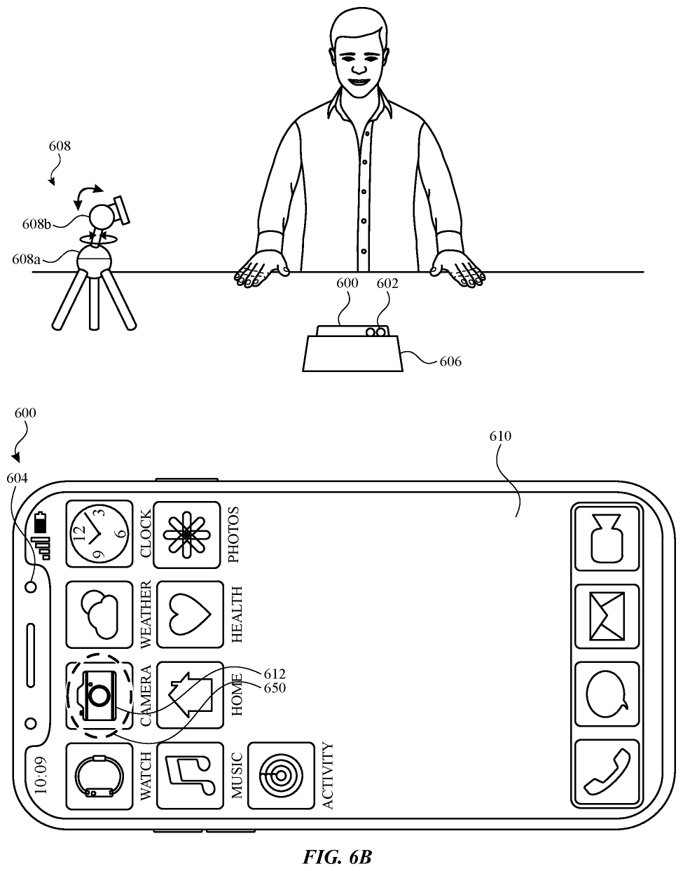

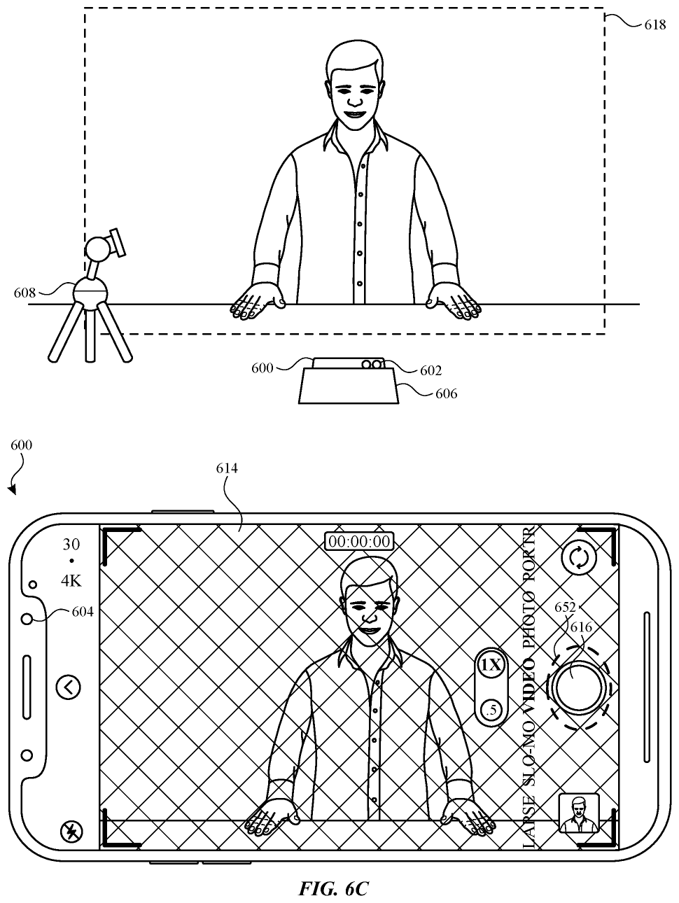

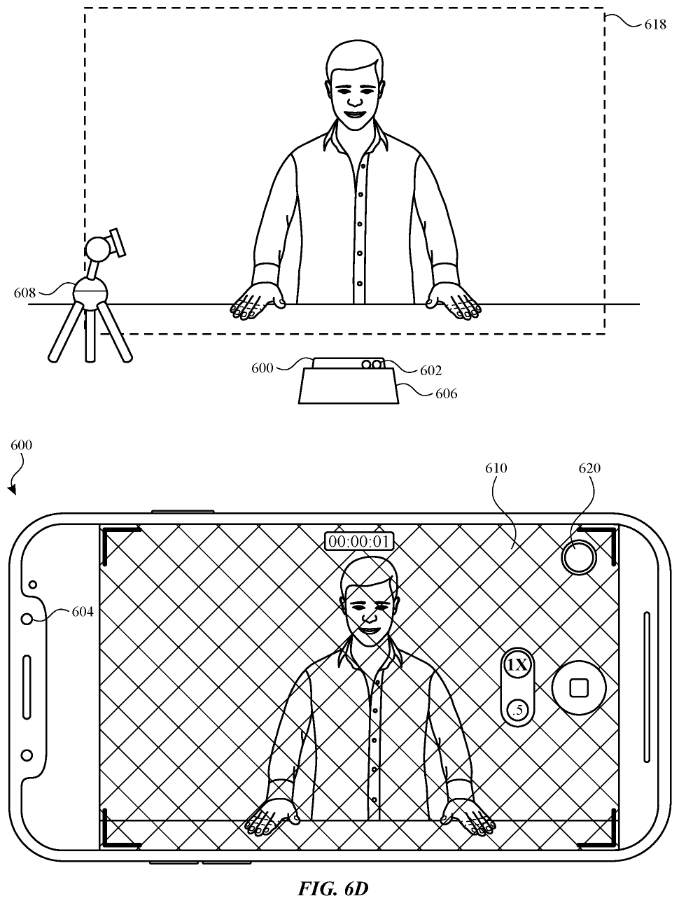

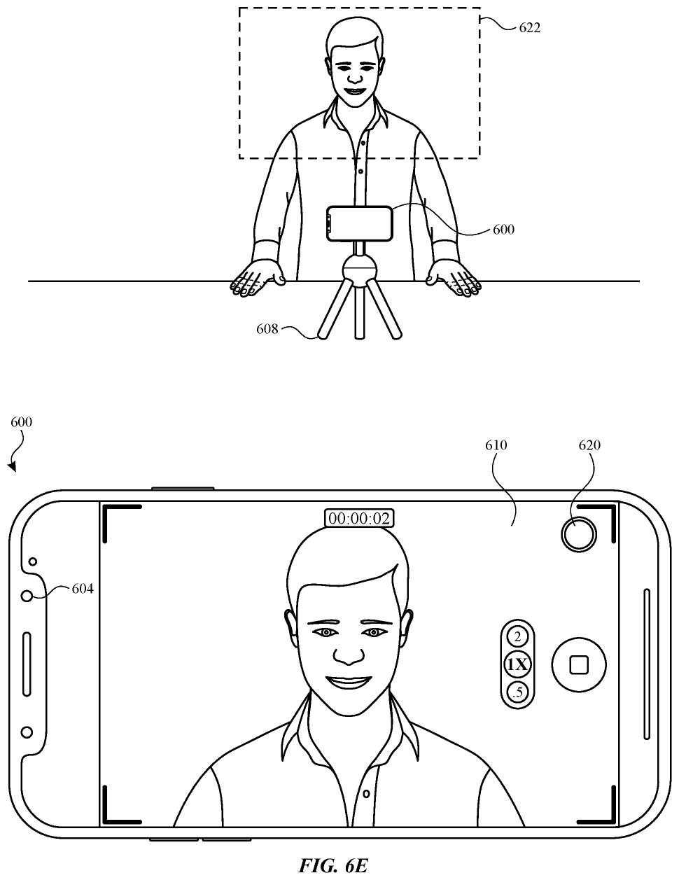

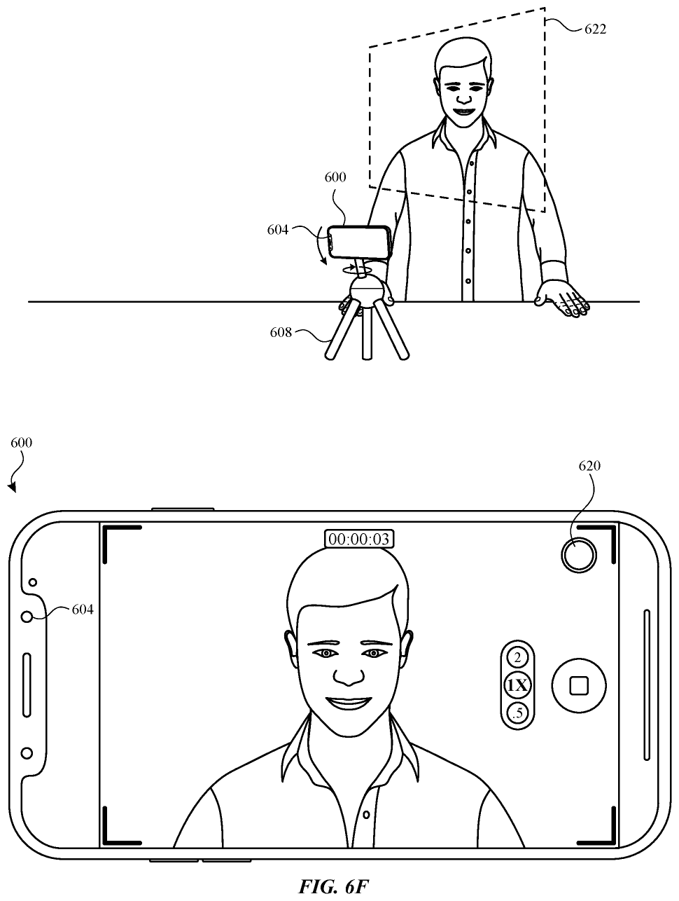

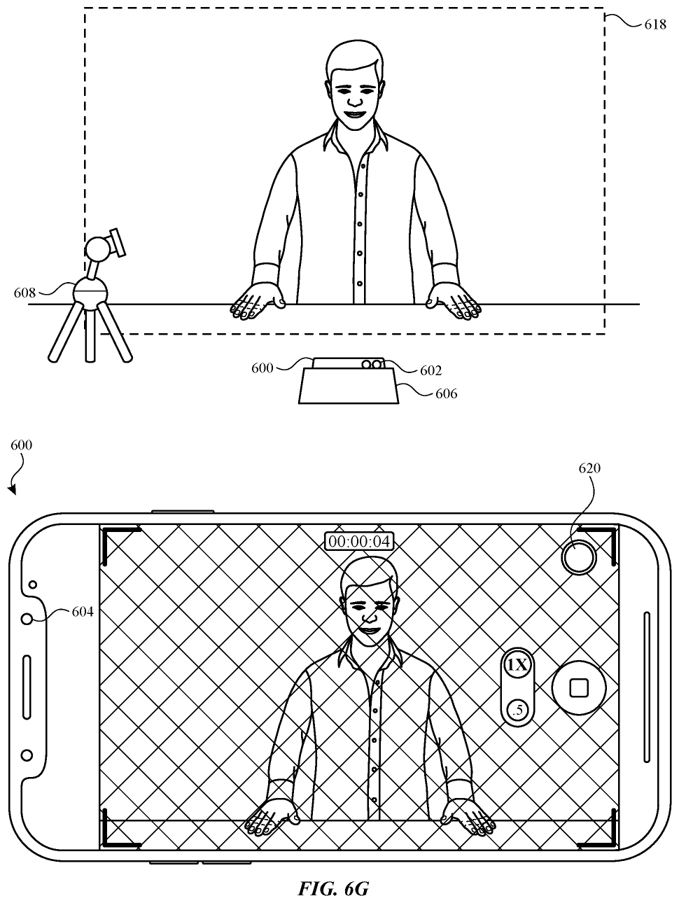

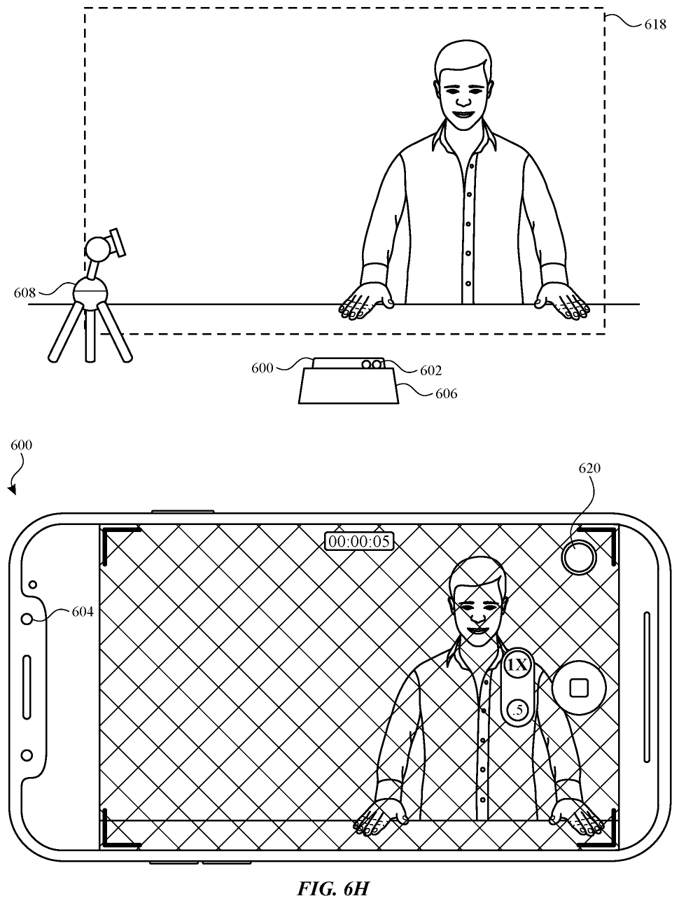

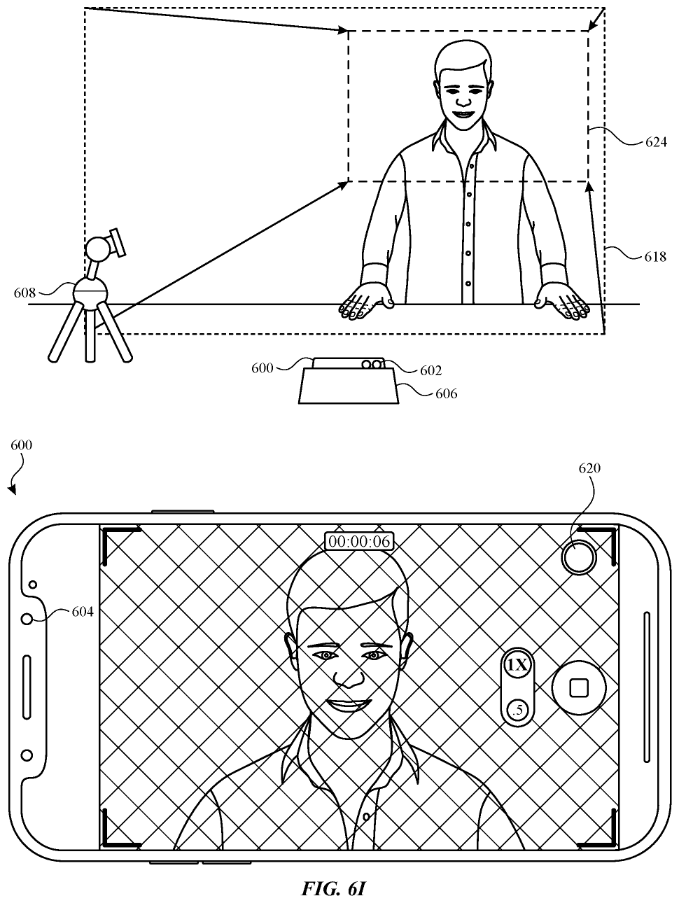

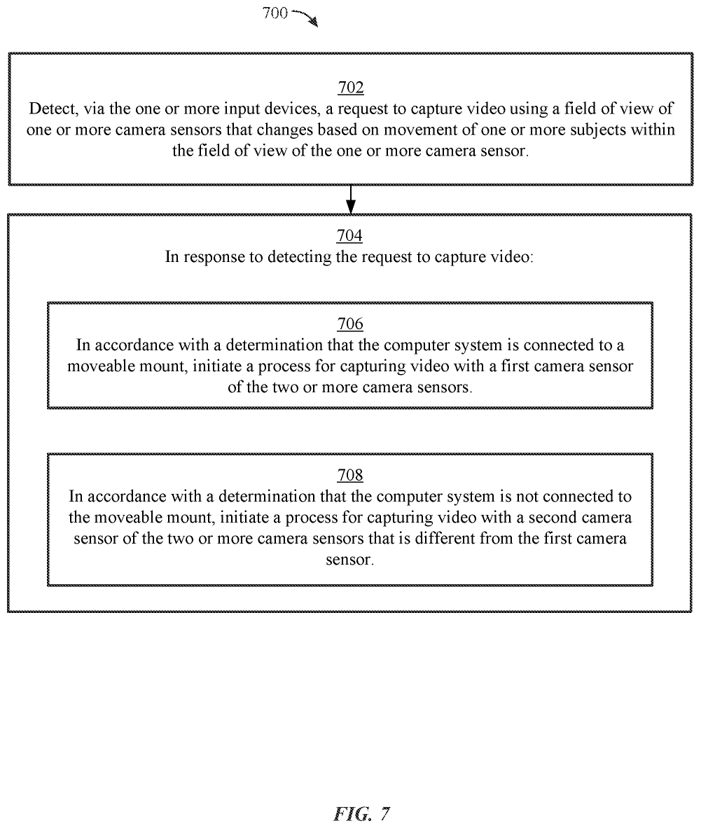

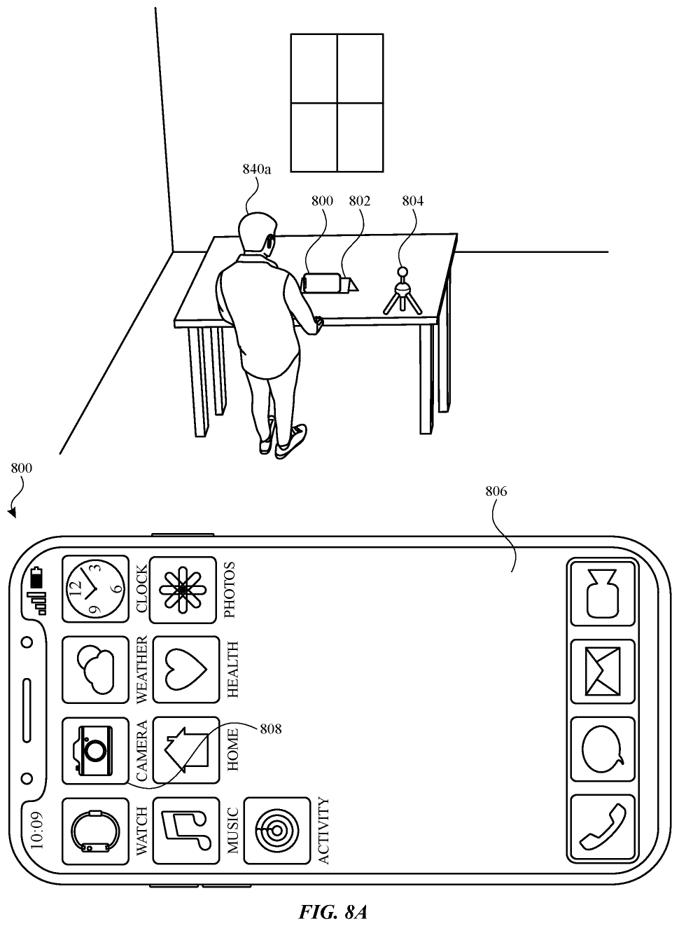

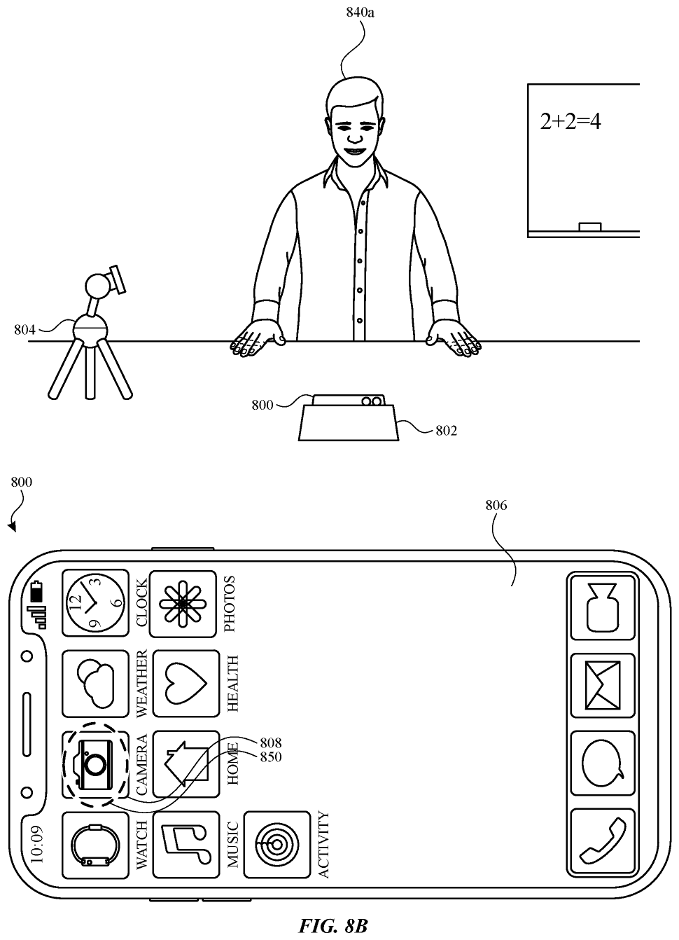

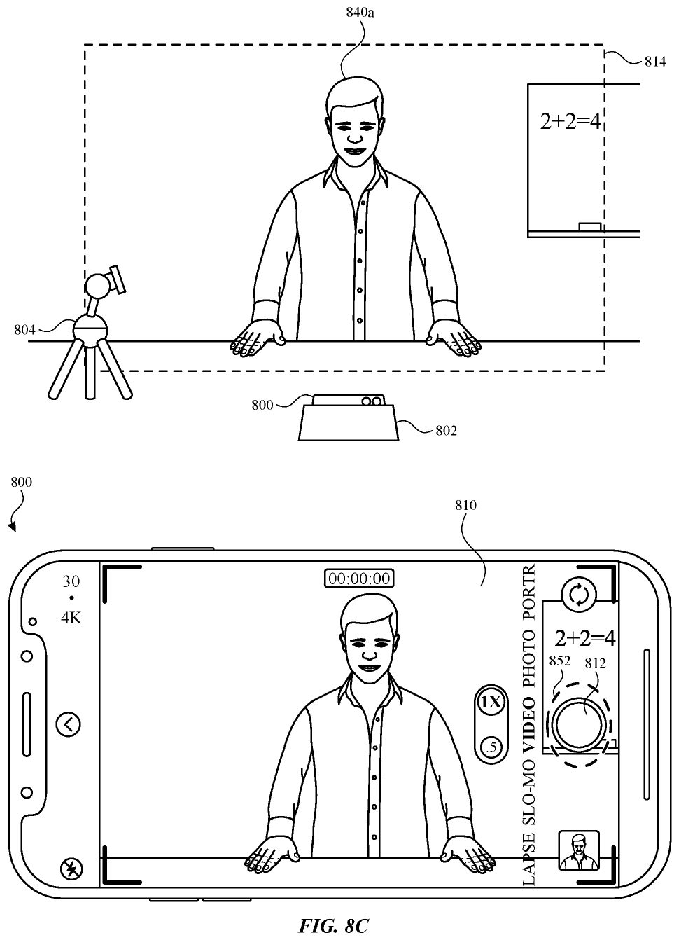

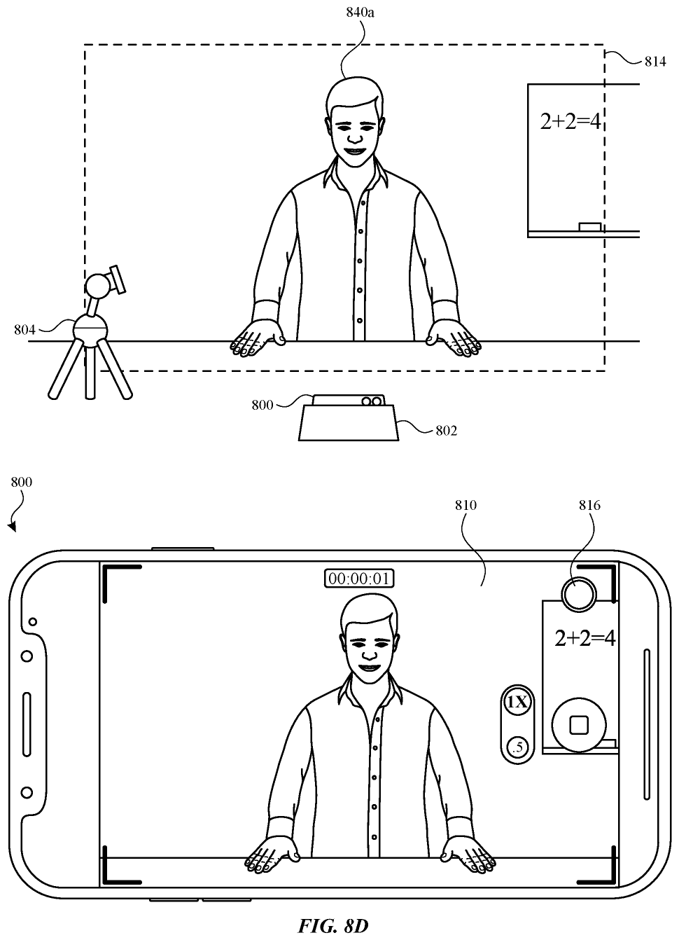

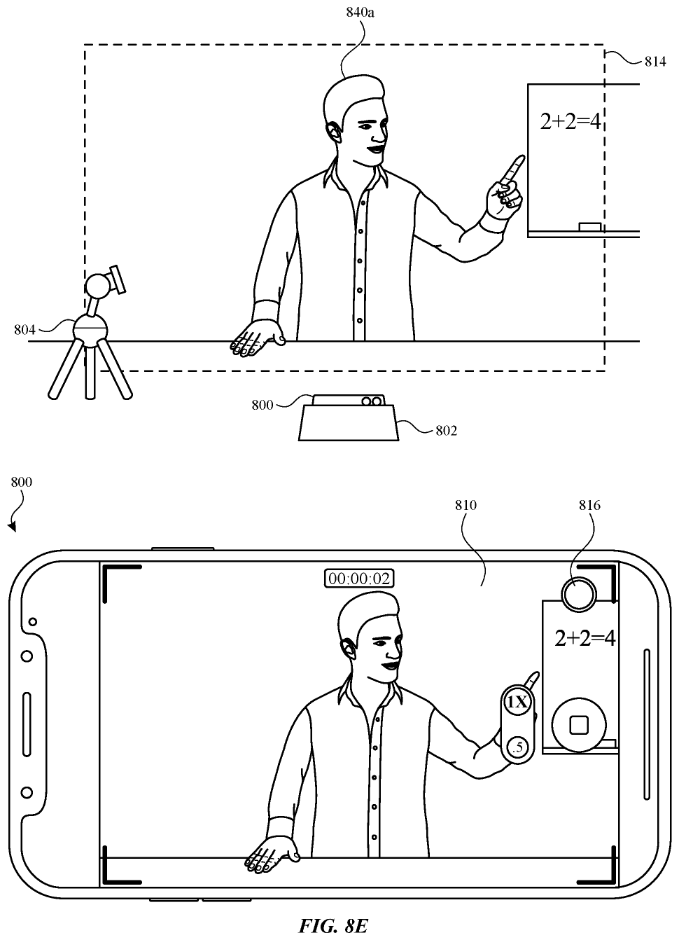

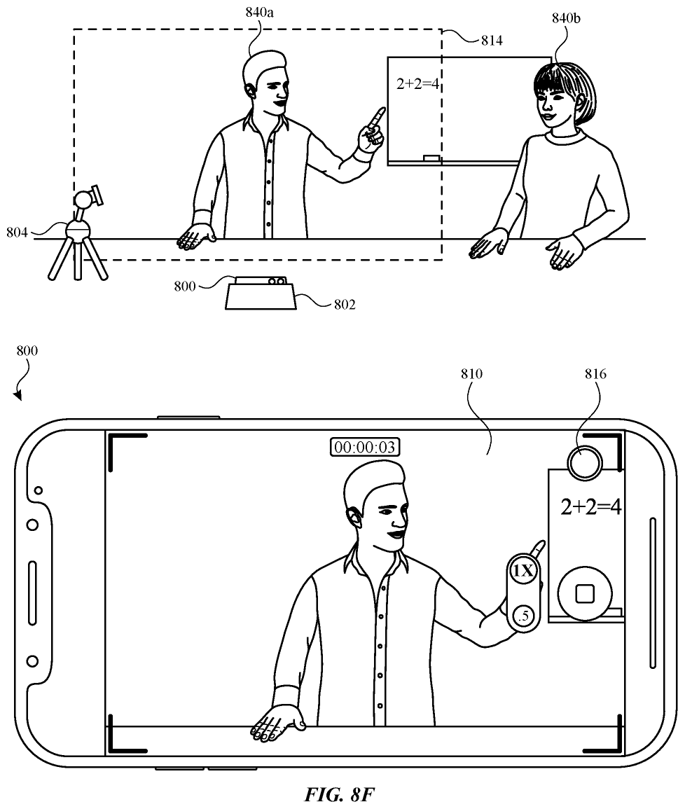

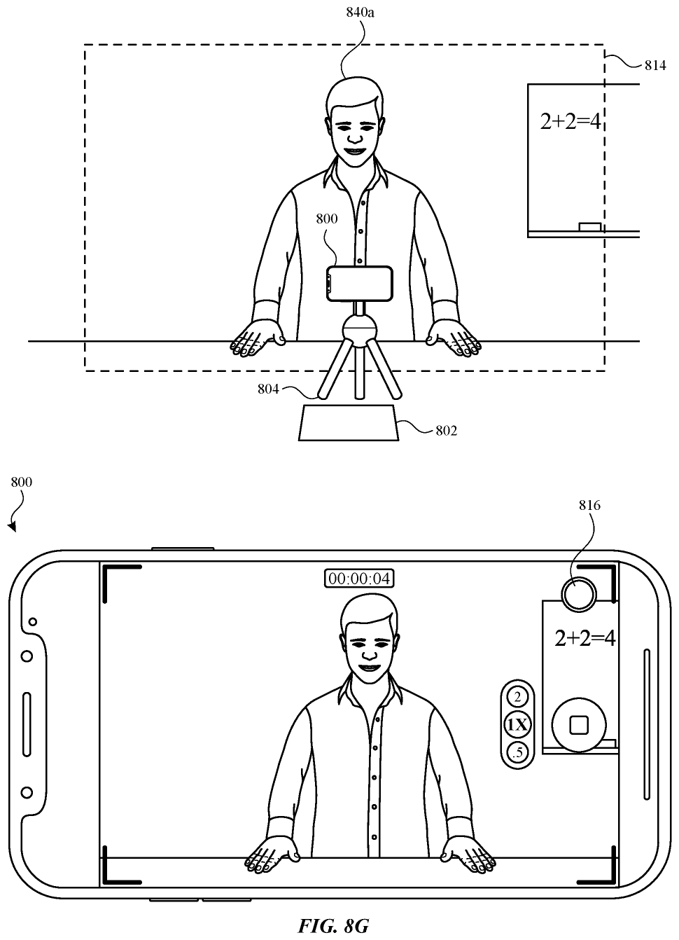

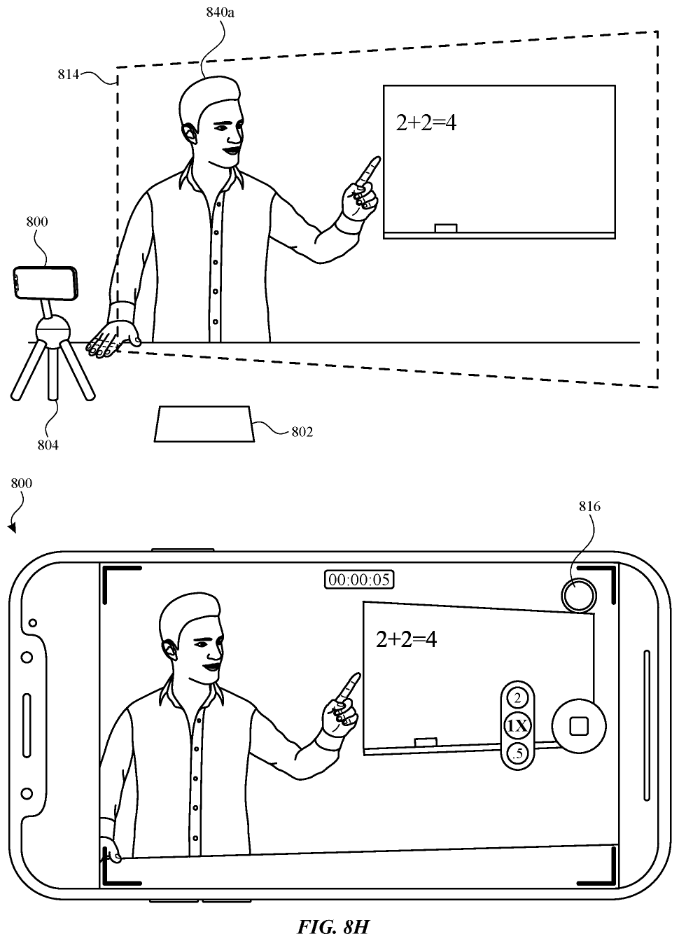

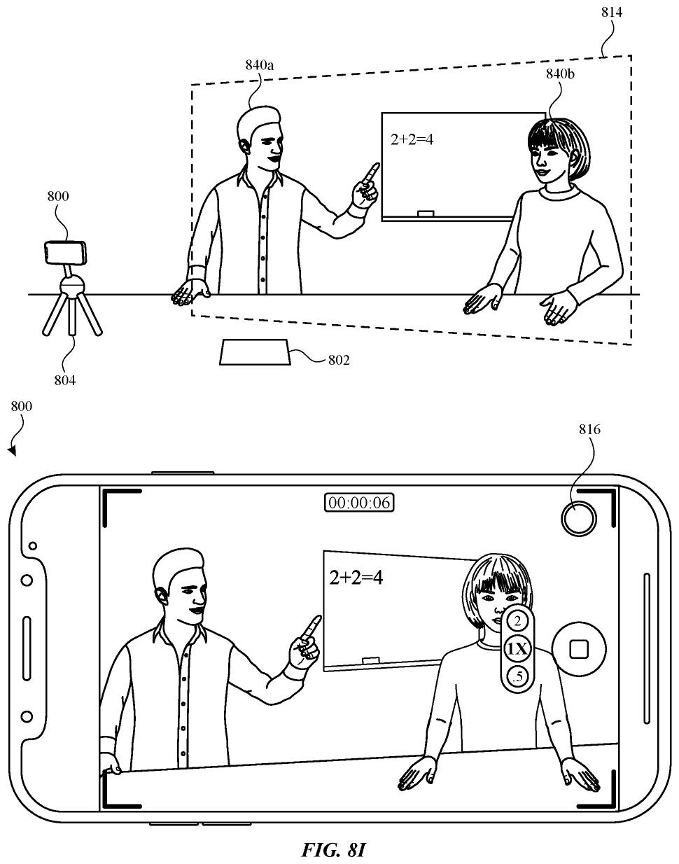

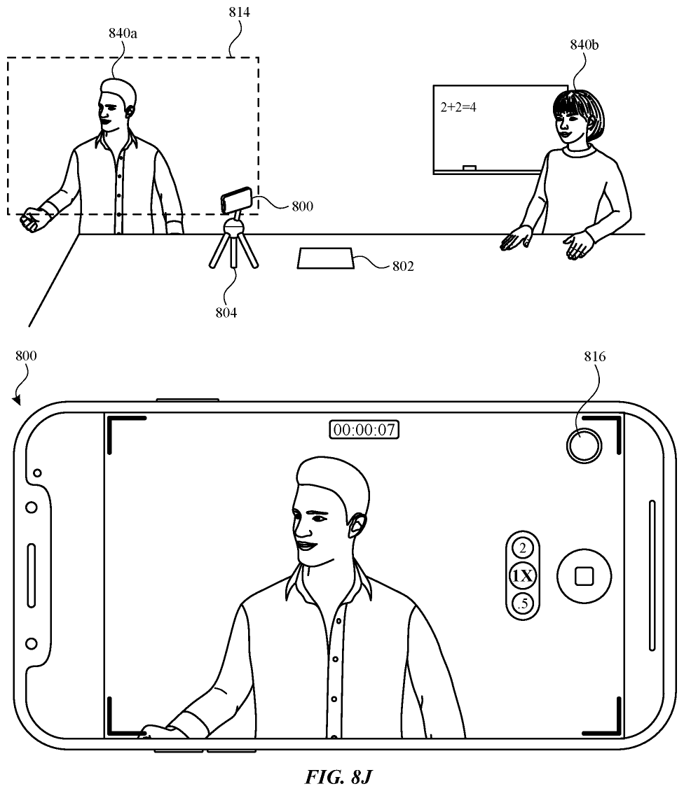

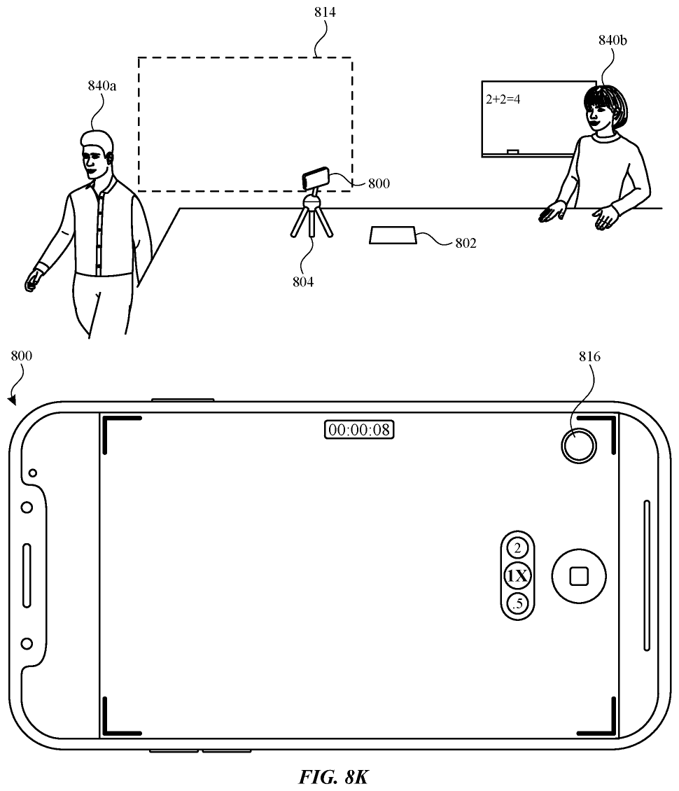

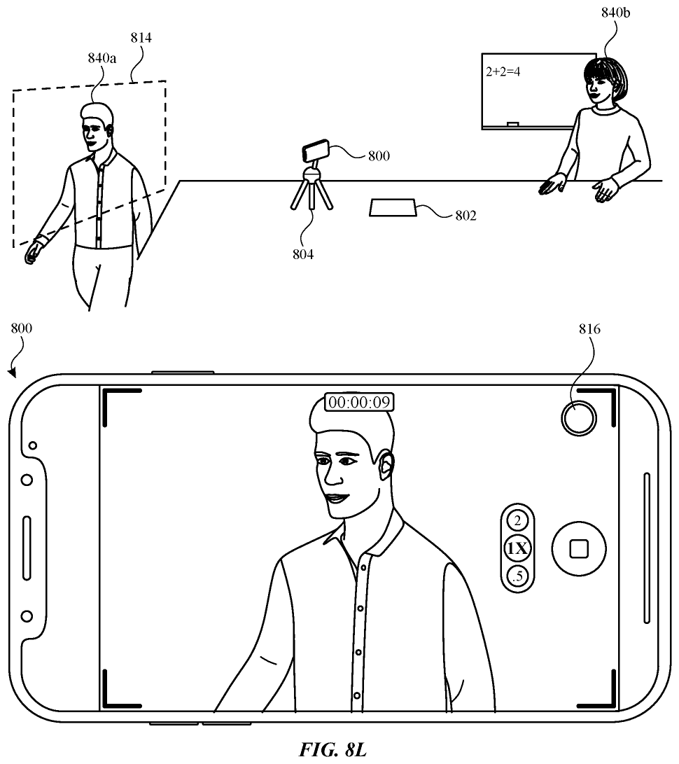

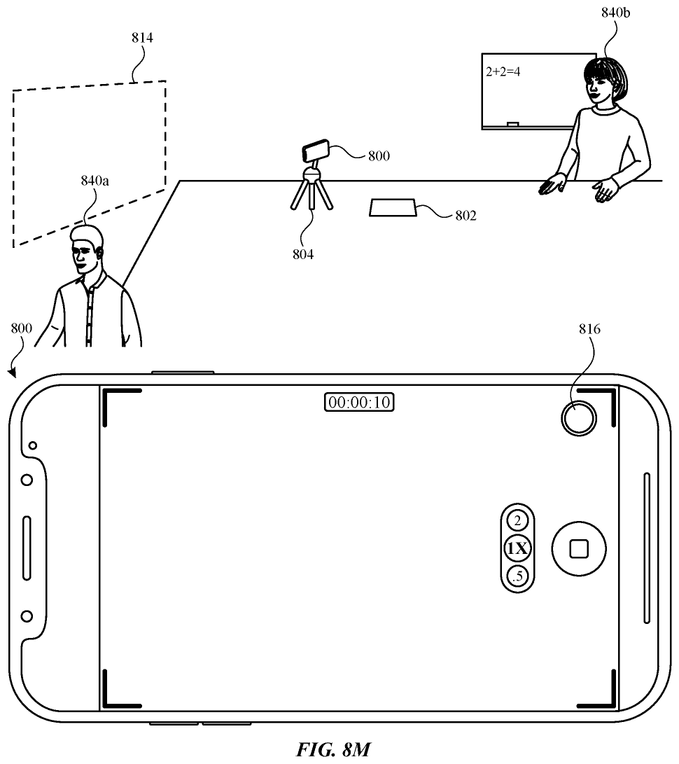

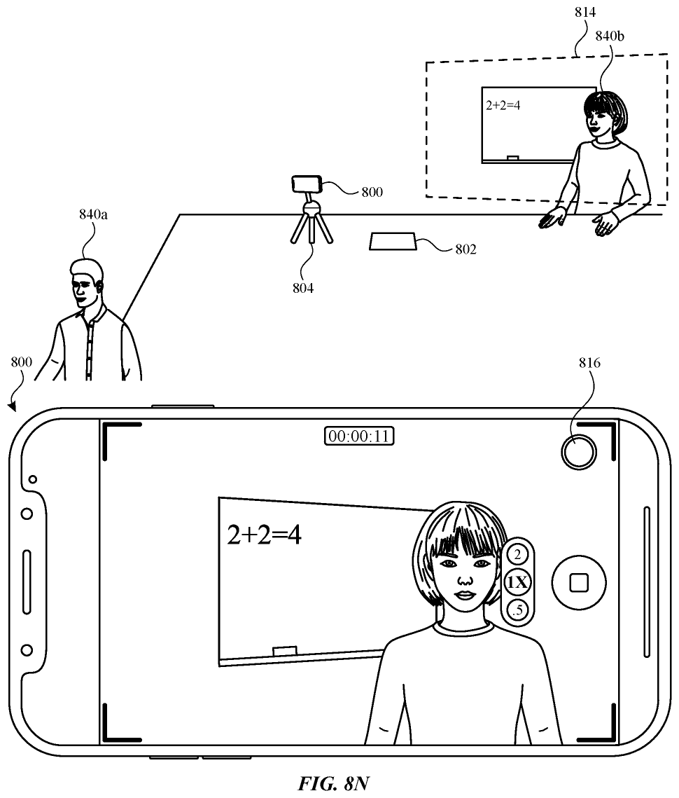

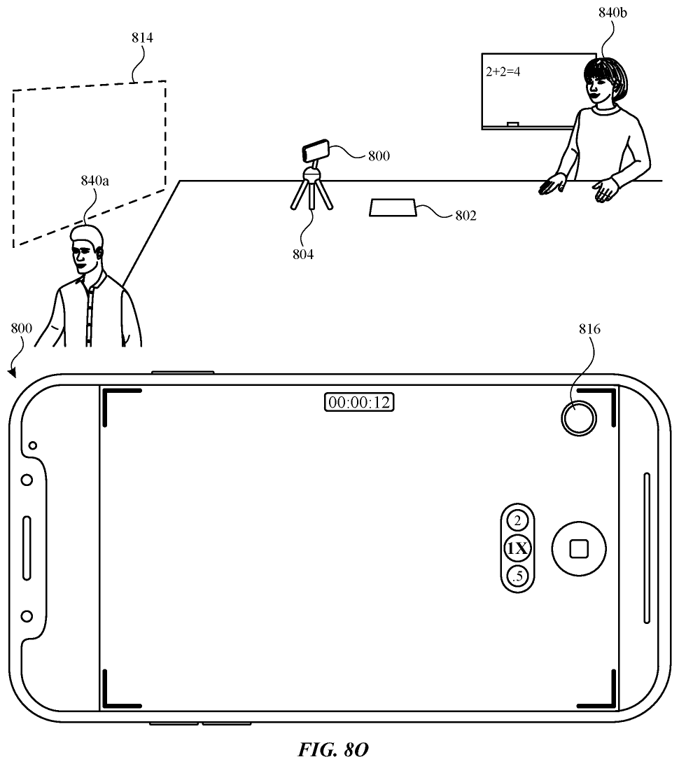

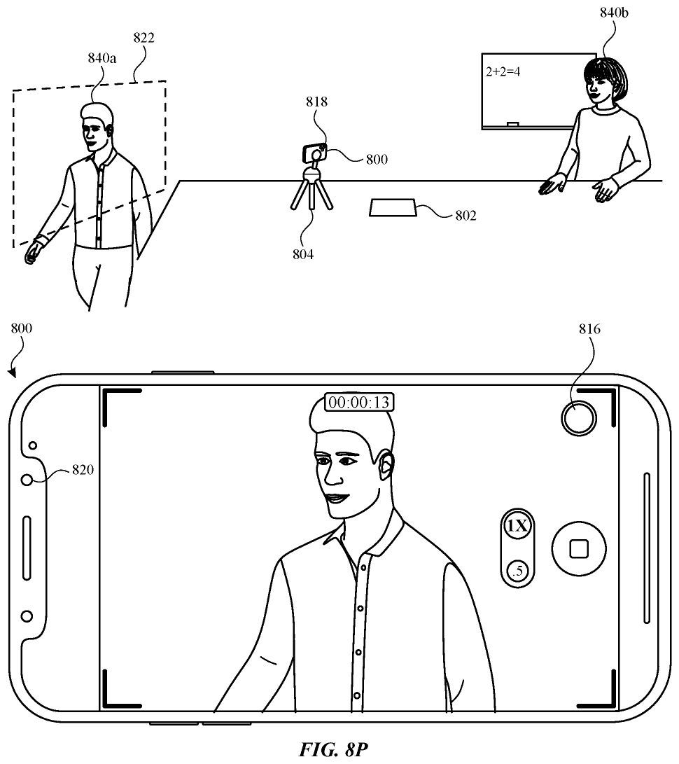

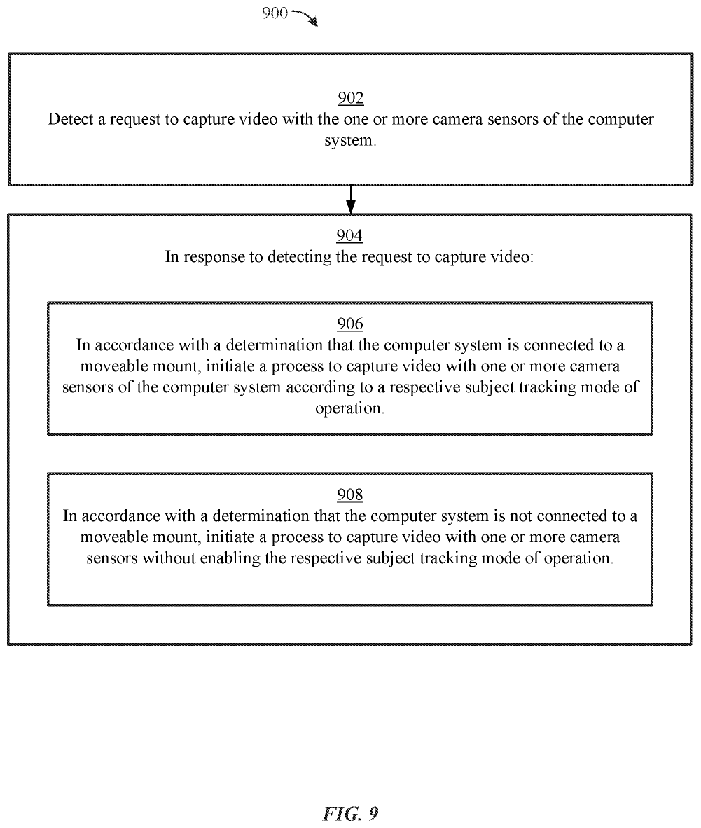

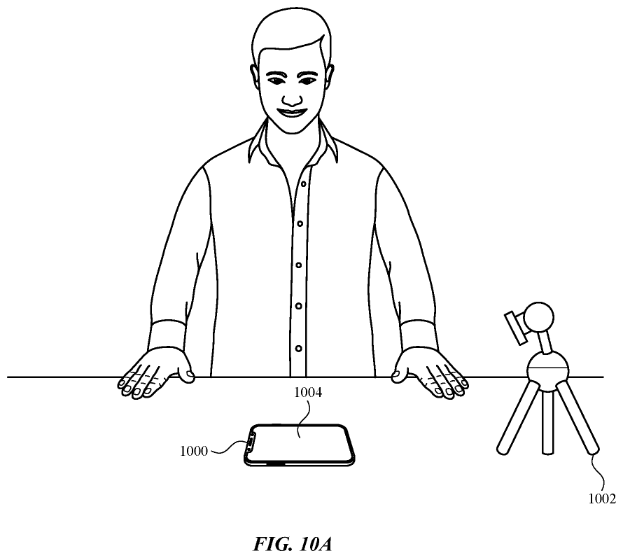

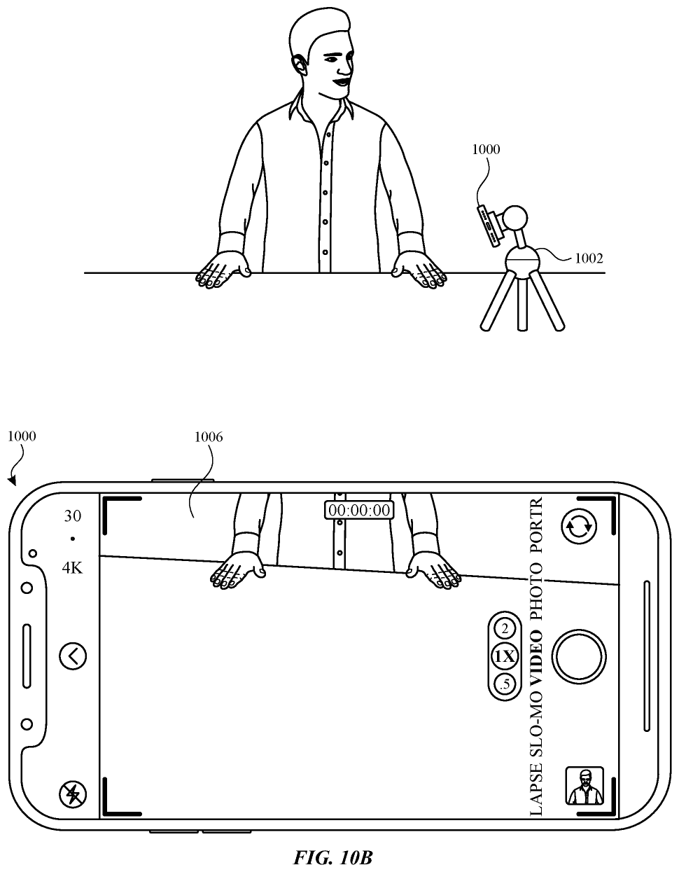

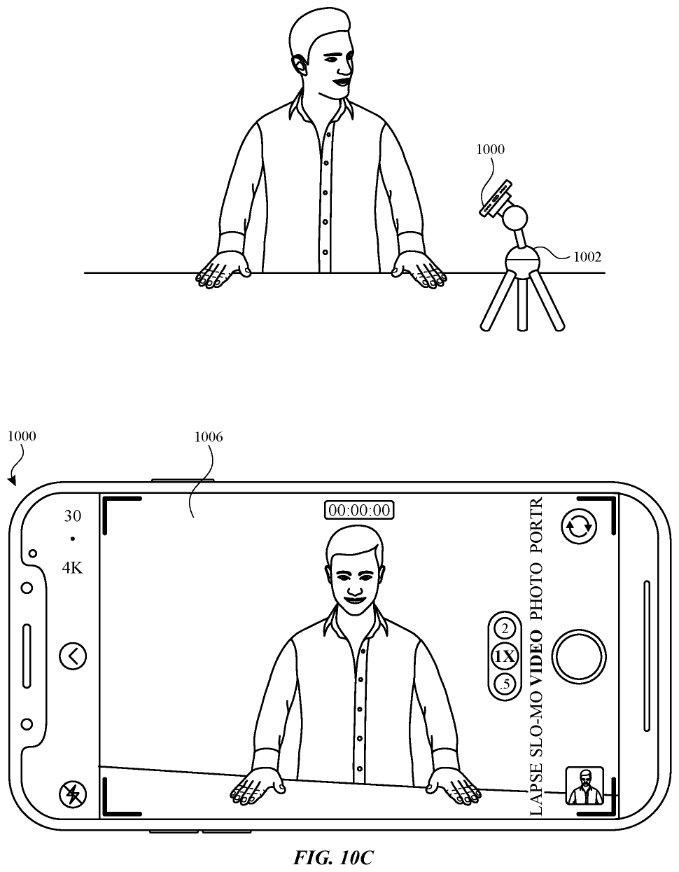

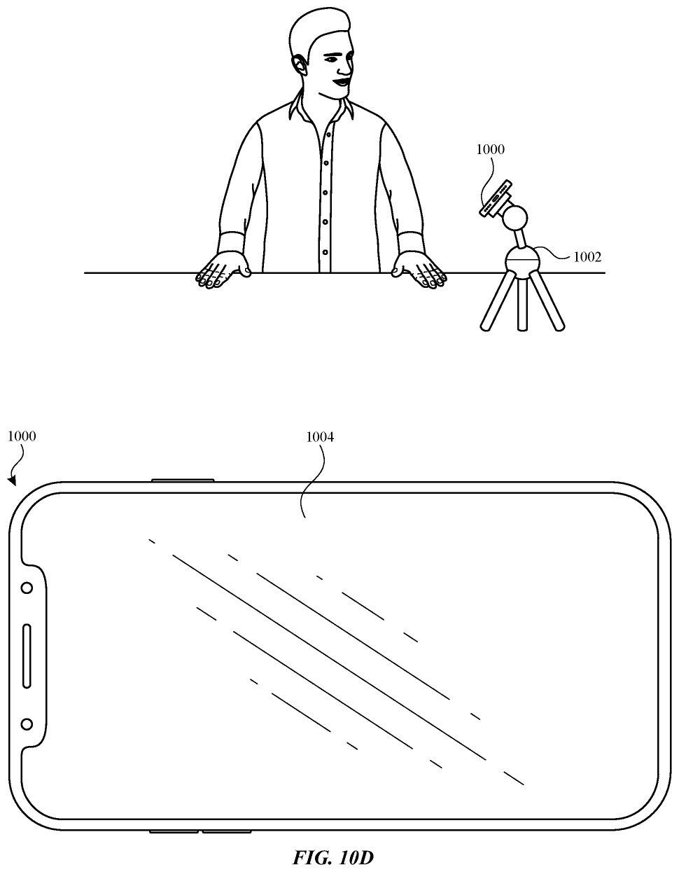

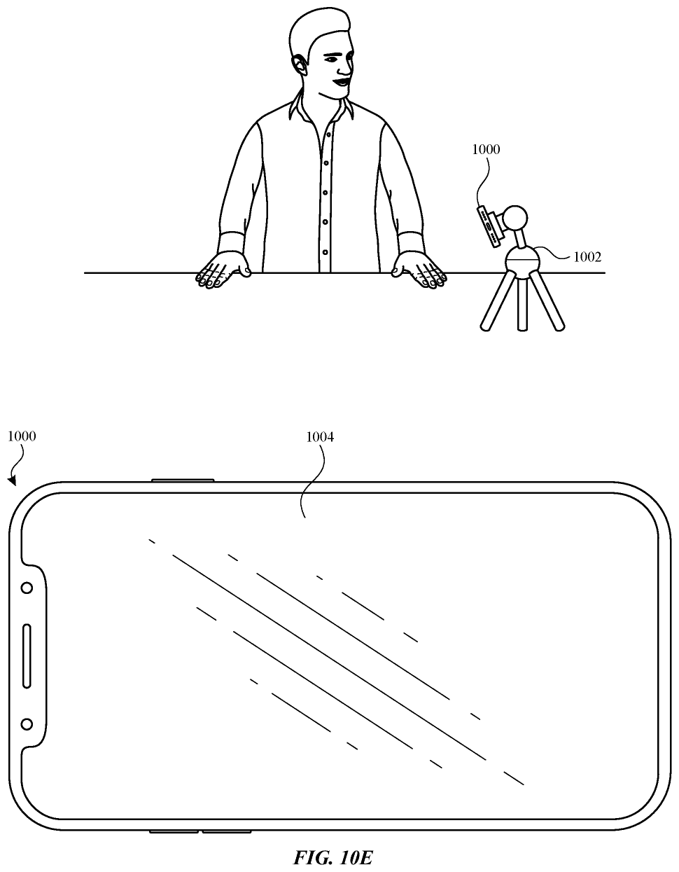

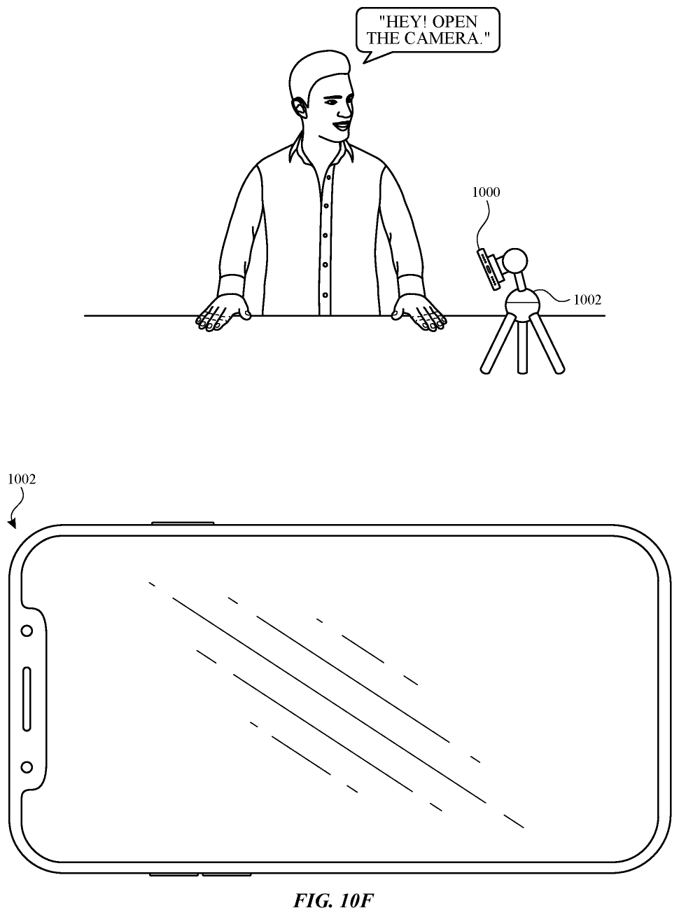

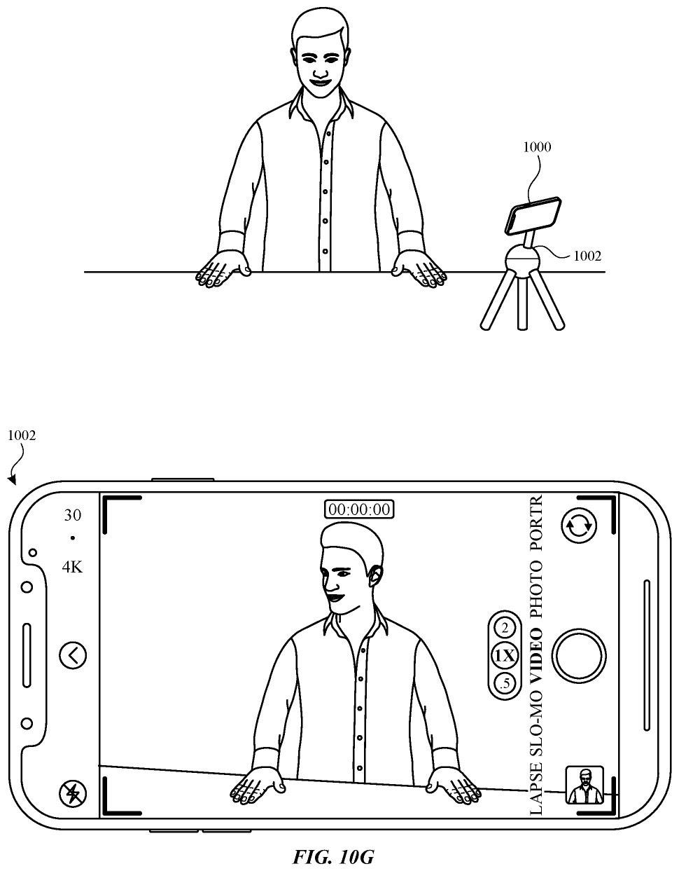

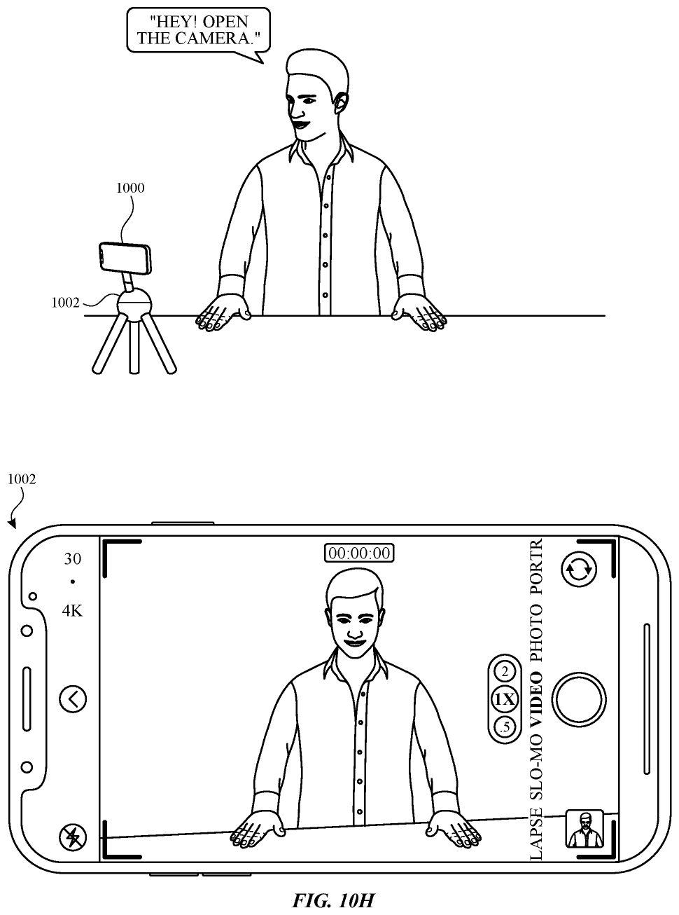

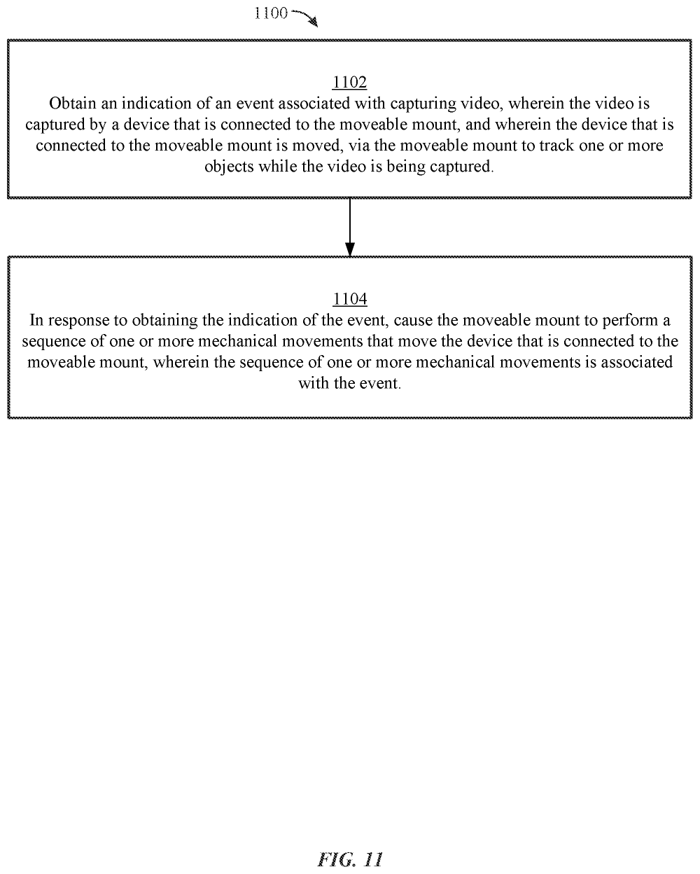

Below, FIGS. 1A-1B, 2, 3, 4A-4B, and 5A-5B provide a description of exemplary devices for performing the techniques for managing event notifications. FIGS. 6A-6I illustrate exemplary techniques and user interfaces for capturing video, in accordance with some embodiments. FIG. 7 is a flow diagram illustrating methods for capturing video in accordance with some embodiments. The user interfaces in FIGS. 6A-6G are used to illustrate the processes described below, including the processes in FIG. 7. FIGS. 8A-8P illustrate exemplary techniques and user interfaces for capturing video, in accordance with some embodiments. FIG. 9 is a flow diagram illustrating methods for capturing video in accordance with some embodiments. The user interfaces in FIGS. 8A-8P are used to illustrate the processes described below, including the processes in FIG. 9. FIGS. 10A-10H illustrate exemplary techniques for performing animations with a moveable mount, in accordance with some embodiments. FIG. 11 is a flow diagram illustrating methods for performing animations with a moveable mount in accordance with some embodiments. The user interfaces in FIGS. 10A-10H are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, increasing privacy, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11 ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

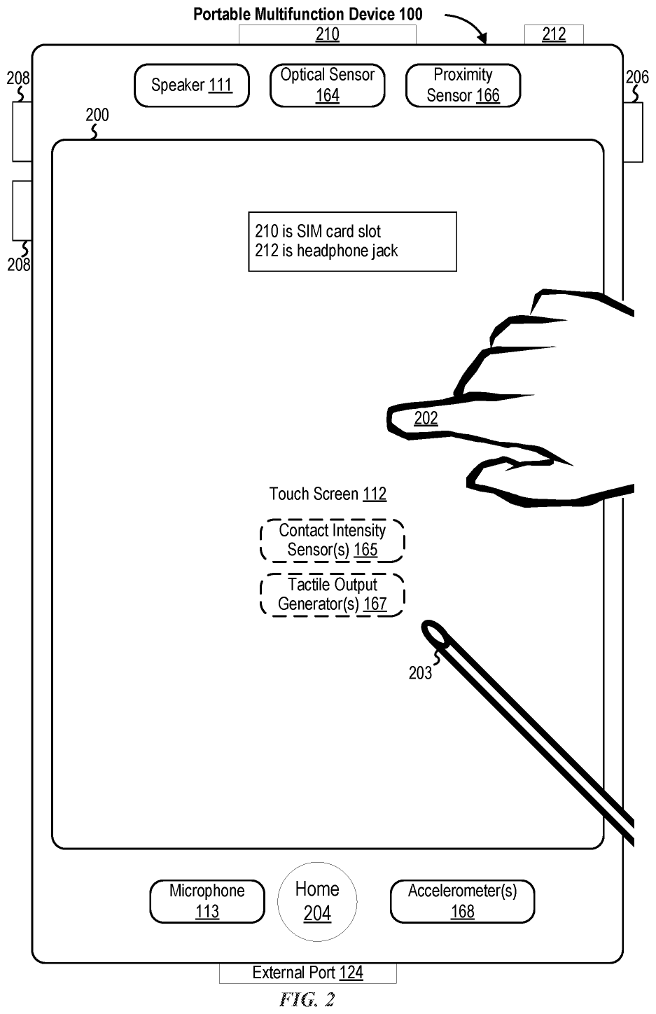

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

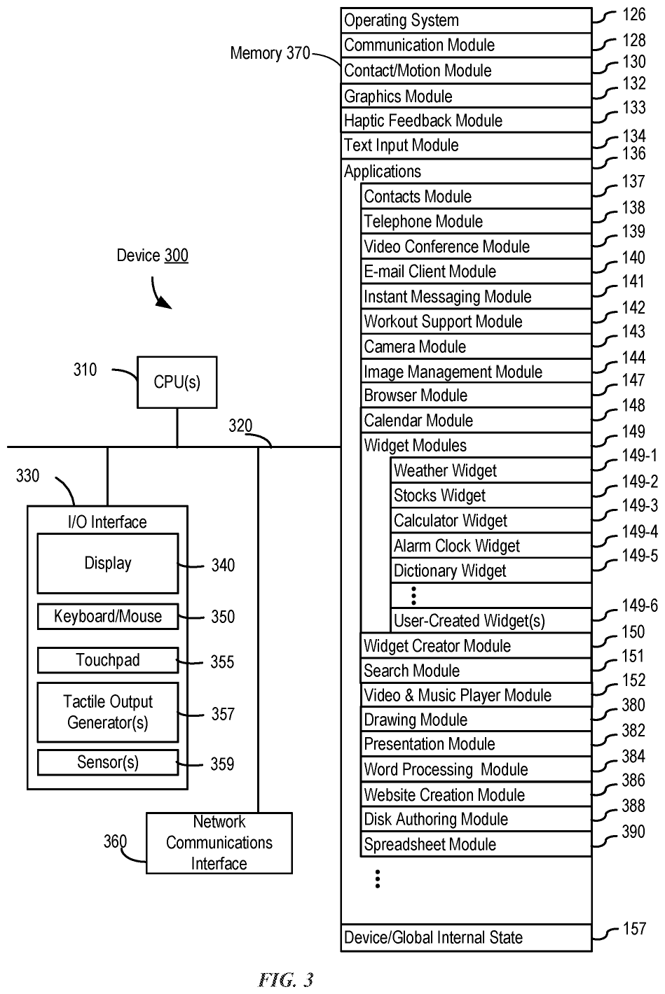

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

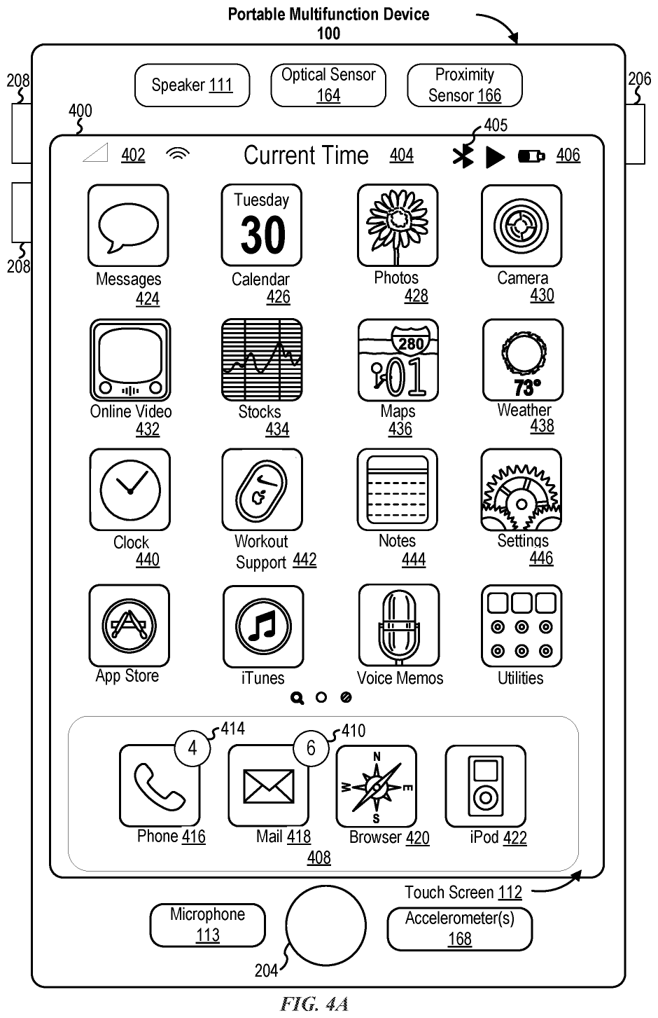

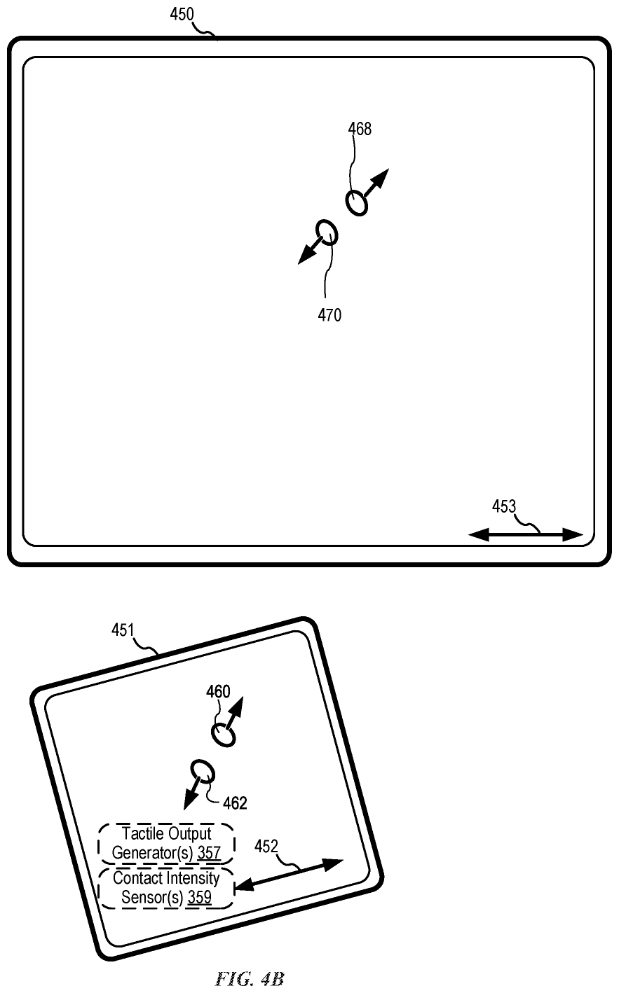

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

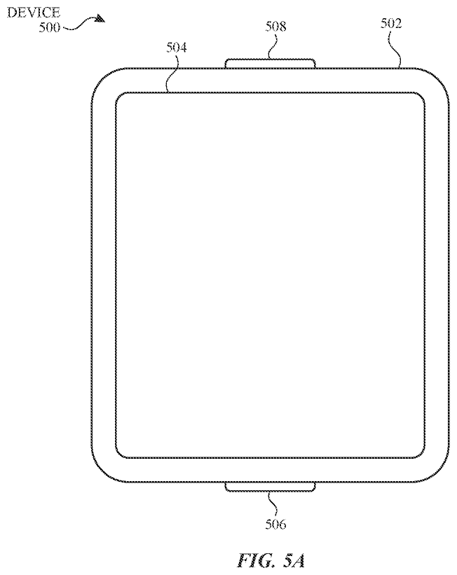

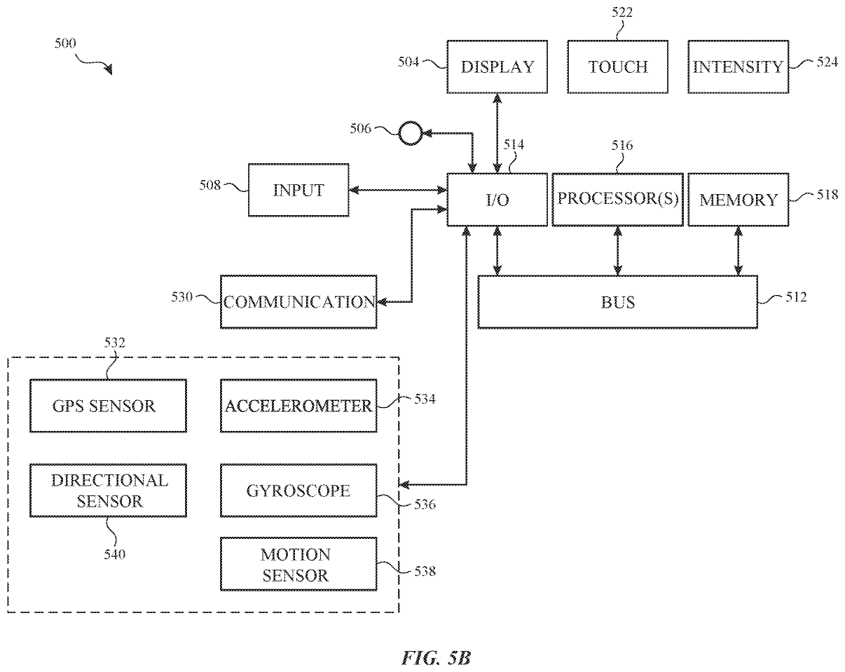

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, and 1100 (FIGS. 7, 9, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6I illustrate exemplary techniques and user interfaces for capturing video with a moveable mount and without a moveable mount, in accordance with some embodiments. The user interfaces in these figures are used to illustrate the processes described below, including the processes in FIG. 7.

FIG. 6A illustrates computer system 600, which includes two or more camera sensors. In FIG. 6A, computer system 600 is a smartphone. In some embodiments, computer system 600 is a tablet computer, a laptop computer, a desktop computer, a smartwatch, a camera device, and/or an electronic control system. In some embodiments, computer system 600 is computer system 800 and/or device 1000 described below. In the embodiment illustrated in FIG. 6A, computer system 600 has first camera sensor 602, which is rear-facing with respect to computer system 600, and second camera sensor 604, which is front-facing with respect to computer system 600. FIG. 6A depicts stand 606 (e.g., a stationary or moveable stand) and moveable mount 608. In some embodiments, stand 606 is stand 802. In some embodiments, moveable mount 608 is moveable mount 804 or moveable mount 1002. As shown in FIG. 6A, computer system 600 is initially resting on stand 606. Computer system 600 has display 610, which is facing a user while computer system 600 is on stand 606.

Computer system 600 can be connected to moveable mount 608. Moveable mount 608 includes one or more mechanisms that enable moveable mount 608 to move, thereby moving computer system 600 when computer system 600 is connected to moveable mount 608. For example, moveable mount 608 can rotate, pan, tilt, and/or roll, thereby causing computer system 600 to rotate, pan, tilt, and/or roll, respectively. In the example shown in FIG. 6B, moveable mount 608 includes two moveable joints, joint 608a and joint 608b. Joint 608a allows rotation around a first axis (e.g., an azimuth axis), enabling moveable mount 608 to pan computer system 600. Joint 608b allows rotation around one or more other axes (e.g., an elevation axis and/or roll axis), enabling moveable mount 608 to tilt and/or roll computer system 600. For example, rotation around a roll axis enables moveable mount 608 to rotate computer system 600 between a portrait orientation and a landscape orientation.

At FIG. 6B, computer system 600 detects input 650 (e.g., a tap and/or other input) selecting camera application icon 612. As illustrated in FIG. 6C, in response to detecting input 650 selecting camera application icon 612, computer system 600 displays camera application user interface 614. Camera application user interface 614 indicates a variety of available camera modes (e.g., video, photo, portrait, lapse, and/or slow-motion). In FIG. 6C, the camera mode is set to video (e.g., as indicated by the video option being centered and bolded compared to the other options) such that computer system 600 will capture and record videos. Camera application user interface 614 includes record control 616. At FIG. 6C, computer system 600 detects input 652 (e.g., a tap and/or other input) on record control 616.

As illustrated in FIG. 6D, in response to detecting input 652 on record control 616, computer system 600 initiates a process to capture video using second camera sensor 604 (e.g., the front facing camera sensor). Second camera sensor 604 has field of view 618 (e.g., indicated by the broken line in the top of FIG. 6D). During the process to capture video using second camera sensor 604, the camera application records video within field of view 618. In FIG. 6D, computer system 600 displays video of field of view 618 on display 610, along with record indicator 620, which indicates that video is being captured.

At FIG. 6E, the user removes computer system 600 from stand 606 and places computer system 600 on moveable mount 608. Because computer system 600 is connected to moveable mount 608 (e.g., in accordance with a determination that the computer system 600 is connected to moveable mount 608), computer system 600 initiates a process to capture video using first camera sensor 602 (e.g., the back facing camera sensor). First camera sensor 602 has field of view 622. In this example, the user placed computer system 600 on moveable mount 608 such that display 610 is facing away from the user and first camera sensor 602 is facing the user. In some embodiments, if the user orients display 610 towards the user and first camera sensor 602 away from the user, moveable mount 608 reorients computer system 600 so that display 610 is facing away from the user and first camera sensor 602 is facing the user.

In this example, first camera sensor 602 has a narrower field of view than second camera sensor 604. The difference is illustrated by field of view 618 of second camera sensor 604 depicted in FIGS. 6C and 6D, which is wider than field of view 622 of first camera sensor 602 depicted in FIG. 6E.

In this example, first camera sensor 602 has a higher image quality than second camera sensor 604. In some embodiments, first camera sensor 602 has reduced image distortion relative to second camera sensor 604 (e.g., due to having a smaller field of view relative to second camera sensor 604) and/or better low light sensitivity relative to second camera sensor 604 (e.g., due to having larger pixels relative to second camera sensor 604). The difference in image quality is illustrated by the hatching shown in FIGS. 6C and 6D, when computer system 600 is using second camera sensor 604 (e.g., the hatching is for illustration purposes only and is not actually displayed on computer system 600). The hatching is not shown, however, in FIG. 6E, when computer system 600 is using first camera sensor 602 due to the higher image quality of second camera sensor 604.

In the embodiment illustrated in FIG. 6F, a respective subject tracking mode of operation is used while (or, in some embodiments, because) computer system 600 is connected to moveable mount 608. In the respective subject tracking mode of operation, computer system 600 adjusts field of view 622 of first camera sensor 602, sends tracking data to moveable mount 608, and/or moves moveable mount 608 in order to track the movement of one or more subjects (e.g., the user and/or an item of interest).

In the example shown in FIG. 6F, the user moves to the side of moveable mount 608. As a result, computer system 600 causes moveable mount 608 to move, thereby changing field of view 622 of first camera sensor 602 so the user remains in field of view 622. In some embodiments, when the respective subject tracking mode of operation is enabled, computer system 600 tracks the one or more subjects mechanically, such as by mechanically zooming first camera sensor 602 and/or mechanically panning first camera sensor 602 by rotating moveable mount 608 so the one or more subjects remain in field of view 622.

In some embodiments, the respective subject tracking mode of operation is automatically enabled in accordance with (or in response to) a determination that computer system 600 is connected to moveable mount 608. In some embodiments, the respective subject tracking mode of operation is automatically disabled in accordance with (or in response to) a determination that computer system 600 is disconnected from moveable mount 608.

In FIG. 6G, computer system 600 is removed from moveable mount 608 and placed on stand 606. As a result, the respective subject tracking mode of operation is automatically disabled and computer system 600 returns to use of second camera sensor 604. FIG. 6G illustrates that computer system 600 displays the wider field of view 618 of second camera sensor 604 with a lower image quality than what was previously displayed in FIG. 6F.

In the embodiment illustrated in FIG. 6H, the user moves to the side of stand 606. However, because the respective subject tracking mode of operation is not enabled, field of view 618 of second camera sensor 604 remains unchanged and the user is no longer centered in field of view 618.

In some embodiments, when the respective subject tracking mode of operation is not enabled, computer system 600 tracks the one or more subjects digitally, but without mechanical adjustments, such as by digitally zooming, panning, tilting and/or rotating second camera sensor 604. For example, FIG. 6I illustrates computer system 600 digitally tracking the user, so that the user is centered in field of view 624 of second camera sensor 604. In this scenario, field of view 618 represents the full extent to which second camera sensor 604 can capture images. However, computer system 600 digitally zooms to field of view 624, limiting the portion of the field of view that is displayed on display 610 so that the user is in the center of the displayed video.

FIG. 7 is a flow diagram illustrating a method for initiating a process to capture video using a computer system in accordance with some embodiments. Method 700 is performed at a computer system (e.g., 100, 300, 500, 600, 800, 1000, a smartphone, a tablet computer, a laptop computer, a desktop computer, a smartwatch, a camera device, and/or an electronic control system) that is in communication with two or more camera sensors and one or more input devices (e.g., a touch-sensitive surface, a touchscreen display, a button, a keyboard, a mouse, a joystick, a camera sensor, and/or a microphone). Some operations in method 700 are, optionally, combined, the orders of some operations are, optionally, changed, and some operations are, optionally, omitted.

As described below, method 700 provides an intuitive way for initiating a process to capture video. The method reduces the cognitive burden on a user for initiating a process to capture video, thereby creating a more efficient human-machine interface. For battery-operated computing devices, enabling a user to initiate a process to capture video faster and more efficiently conserves power and increases the time between battery charges.

The computer system detects (702), via the one or more input devices, a request (e.g., a set of one or more inputs) (e.g., 650 and/or 652) to capture video using a field of view (e.g., 618) of one or more camera sensors (e.g., 602 and/or 604) (e.g., a field of view of a first camera sensor of the two or more camera sensors and/or a field of view of a second camera sensor of the two or more camera sensors) that changes (e.g., is adjusted mechanically and/or electronically) based on movement of one or more subjects within the field of view of the one or more camera sensors (e.g., the movement of the man from his position in FIG. 6E to his position in FIG. 6F). In some embodiments, the field of view is adjusted (e.g., translated and/or zoomed in or out) to follow or track a user or object that moves from one location to another.

In response to detecting the request to capture video (704): in accordance with (e.g., in response to) a determination that the computer system is connected to (e.g., physically connected to, physically mounted on, and/or in communication with via a wired or wireless connection) a moveable mount (e.g., 608) (e.g., a mount that is configured to physically hold or support the computer system via gravity, a magnetic mechanism, and/or a mechanical mechanism) (e.g., computer system 600 is connected to moveable mount 608 in FIG. 6E), the computer system initiates (706) a process for capturing video with a first camera sensor (e.g., 602) of the two or more camera sensors. In some embodiments, the mount has motors and/or controls that enable rotation, panning (e.g., rotation around a vertical axis), tilting (e.g., rotation around a horizontal axis), and/or rolling (e.g., rotation around a second horizontal axis perpendicular to the horizontal axis and the vertical axis) of one or more portions of the mount. In some embodiments, the computer system has a rechargeable battery and, when the computer system is connected to the moveable mount, the moveable mount charges the battery (e.g., via wireless charging). In some embodiments, initiating the process for capturing video includes displaying a selectable graphical element (e.g., a button, icon, and/or affordance) that, when selected, causes video to be captured (e.g., via one or more of the one or more camera sensors). In some embodiments, initiating the process for capturing video includes detecting a series of inputs including an input that corresponds to a request to launch an application for capturing video (e.g., a camera application). In some embodiments, initiating the process for capturing video includes performing the process for capturing video and/or capturing video.

In response to detecting the request to capture video (704): in accordance with (e.g., in response to) a determination that the computer system is not connected to (e.g., not physically connected to, not physically mounted on, and/or not in communication with) the moveable mount (e.g., computer system 600 is on stand 606 in FIG. 6B), the computer system initiates (708) a process for capturing video with a second camera sensor (e.g., 604) of the two or more camera sensors that is different from the first camera sensor. Using a first camera sensor when the computer system is connected to a moveable mount and using a second camera sensor when the computer system is not connected to a moveable mount enables the computer system to use a better camera for capturing video in a given situation without requiring additional input from a user, thereby performing an improved operation when a set of conditions has been met without requiring further user input and reducing the number of inputs needed to perform an operation.

In some embodiments, the first camera sensor has a narrower field of view than the second camera sensor (e.g., 622 as compared with 618) (e.g., the second camera is a wide-angle camera). Initiating a process for capturing video with a camera sensor that has a narrower field of view when the computer system is connected to a moveable mount enables the computer system to automatically use a camera with better optical properties for capturing video, thereby performing an improved operation when a set of conditions has been met without requiring further user input and reducing the number of inputs needed to perform an operation.

In some embodiments, the first camera sensor has a higher image quality (e.g., higher resolution) than the second camera sensor (e.g., image shown in FIG. 6E as compared with hatched image shown in FIG. 6D). Initiating a process for capturing video with a camera sensor that has a higher image quality when the computer system is connected to a moveable mount enables the computer system to automatically use a camera with better optical properties for capturing video, thereby performing an improved operation when a set of conditions has been met without requiring further user input and reducing the number of inputs needed to perform an operation.

In some embodiments, while a respective subject tracking mode is disabled, the computer system detects that the computer system has been attached to the moveable mount. In some embodiments, in response to detecting that the computer system has been connected to the moveable mount, the computer system enables the respective subject tracking mode of operation (e.g., enables tracking movements of the man shown in FIGS. 8G-8P) (e.g., tracking is automatically enabled when the computer system is connected to the moveable mount). In some embodiments, enabling the respective subject tracking mode of operation includes enabling a respective subject tracking algorithm, adjusting a field of view of a camera sensor, sending tracking data to the moveable mount (e.g., from the computer system), and/or moving the moveable mount (e.g., according to the tracking data). In some embodiments, in the respective subject tracking mode of operation, the computer system adjusts the field of view of the first camera sensor, sends tracking data to the moveable mount, and/or moves the moveable mount in order to track the movement of one or more subjects (e.g., the user and/or an item of interest). In some embodiments, when the respective subject tracking mode of operation is enabled, the computer system tracks the one or more subjects mechanically, such as by mechanically zooming the first camera sensor and/or mechanically panning the first camera sensor by rotating the moveable mount so the one or more subjects remain in the field of view. In some embodiments, when the respective subject tracking mode of operation is enabled, the computer system tracks the one or more subjects by combining mechanical and digital adjustments to the field of view (e.g., mechanically panning the first camera sensor by rotating the moveable mount and digitally zooming the first camera sensor). Automatically enabling a respective subject tracking mode of operation when the computer system is connected to a moveable mount reduces the number of inputs required to enable the respective subject tracking mode of operation and allows the user to enable the respective subject tracking mode of operation without displaying additional controls, which performs an operation when a set of conditions has been met without requiring further user input, reduces the number of inputs needed to perform an operation, and provides additional control options without cluttering the user interface with additional displayed controls.

In some embodiments, in accordance with (or, in some embodiments, in response to) a determination that the computer system is removed from the moveable mount, the computer system disables a respective subject tracking mode of operation (e.g., tracking is automatically disabled when the computer system is disconnected from the moveable mount) (e.g., as described with reference to FIG. 6G). In some embodiments, while the respective subject tracking mode of operation is enabled, the computer system receives (e.g., detects) an indication of removal of the computer system from the moveable mount; and in response to receiving the indication of removal of the computer system from the moveable mount, the computer system disables the respective subject tracking mode of operation. Automatically disabling a respective subject tracking mode of operation in accordance with a determination that the computer system is removed from a moveable mount reduces the number of inputs required to disable the respective subject tracking mode of operation and allows the user to disable the respective subject tracking mode of operation without displaying additional controls, which performs an operation when a set of conditions has been met without requiring further user input, reduces the number of inputs needed to perform an operation, and provides additional control options without cluttering the user interface with additional displayed controls.

In some embodiments, the computer system detects a change in spatial arrangement of one or more subjects (e.g., the change in position of the man from his position in FIG. 6E to his position in FIG. 6F) detected by the one or more camera sensors (e.g., one or more subjects appearing, one or more subjects disappearing, and/or one or more subjects moving in the physical environment). In some embodiments, in response to detecting the change in spatial arrangement of the one or more subjects, changing a field of view of the one or more camera sensors to track one or more of the subjects based on the change in spatial arrangement of the one or more subjects (e.g., change in field of view 622 from FIG. 6E to FIG. 6F). Changing a field of view of the camera sensors to track one or more subjects in response to detecting a change in spatial arrangement of the one or more subjects reduces the number of inputs required to track one or more subjects based on the change in spatial arrangement of the subjects, thereby performing an operation when a set of conditions has been met without requiring further user input and reducing the number of inputs needed to perform an operation.

In some embodiments, changing the field of view of the one or more camera sensors to track one or more of the subjects based on the change in spatial arrangement of the one or more subjects includes: in accordance with a determination that the first camera sensor is being used to capture video (and/or, in some embodiments, in accordance with a determination that the computer system is connected to the moveable mount), mechanically changing the field of view of the one or more camera sensors (e.g., mechanically moving computer system 600, and thereby first camera sensor 602 and corresponding field of view 622, from the position shown in FIG. 6E to the position shown in FIG. 6F) (e.g., mechanically zooming the first camera sensor and/or mechanically panning the first camera sensor by rotating the moveable mount to maintain the one or more subjects in the field of view of the one or more camera sensors). In some embodiments, changing the field of view of the one or more camera sensors to track one or more of the subjects based on the change in spatial arrangement of the one or more objects includes both mechanically and digitally changing the field of view of the one or more camera sensors. In some embodiments, mechanically tracking the one or more subjects includes adjusting one or more physical components of the first camera sensor, computer system, and/or moveable mount in order to change the field of view of the first camera sensor, such as zooming, panning, tilting, and/or rotating the field of view of the first camera sensor. In some embodiments, the one or more subjects includes a person and/or an object of interest. Mechanically tracking one or more subjects in accordance with a determination that the first camera sensor is being used to capture video enables the computer system to use improved settings for tracking a subject when using the first camera sensor, thereby performing an operation when a set of conditions has been met without requiring further user input and reducing the number of inputs needed to perform an operation.

In some embodiments, changing the field of view of the one or more camera sensors to track one or more of the subjects based on the change in spatial arrangement of the one or more subjects includes: in accordance with a determination that the second camera sensor is being used to capture video (and/or, in some embodiments, in accordance with a determination that the computer system is not connected to the moveable mount) digitally changing the field of view of the one or more camera sensors (e.g., changing from field of view 618 to field of view 624 in FIG. 6I) (e.g., digitally zooming the second camera sensor and/or digitally panning the second camera sensor without mechanical adjustments to maintain the one or more subjects in the field of view of the one or more camera sensors). In some embodiments, digitally tracking the one or more subjects includes digitally adjusting the first camera sensor, such as zooming, panning, tilting and/or rotating the field of view of the second camera sensor. In some embodiments, the one or more subjects includes a person and/or an object of interest. Digitally tracking one or more subjects in accordance with a determination that the second camera sensor is being used to capture video enables the computer system to use improved settings fbr tracking a subject when using the second camera sensor, thereby performing an operation when a set of conditions has been met without requiring further user input and reducing the number of inputs needed to perform an operation.

Note that details of the processes described above with respect to method 700 (e.g., FIG. 7) are also applicable in an analogous manner to the methods described below. For example, method 900 and method 1100 optionally include one or more of the characteristics of the various methods described above with reference to method 700. For example, methods for capturing video with a first camera sensor or a second camera sensor can be combined with methods for capturing video in accordance with a respective subject tracking mode of operation, based at least in part on whether the computer system is connected to a moveable mount. For brevity, these details are not repeated below.

FIGS. 8A-8P illustrate exemplary techniques and user interfaces for capturing video with a moveable mount and without a moveable mount, in accordance with some embodiments. The user interfaces in these figures are used to illustrate the processes described below, including the processes in FIG. 9.

FIG. 8A illustrates computer system 800, stand 802, and moveable mount 804. In FIG. 8A, computer system 800 is a smartphone. In some embodiments, computer system 800 is a tablet computer, a laptop computer, a desktop computer, a smartwatch, a camera device, and/or an electronic control system. As shown in FIG. 8A, computer system 800 is initially resting on stand 802. Computer system 800 has display 806, which is facing a user while computer system 800 is on stand 802. In some embodiments, computer system 800 is computer system 600 and/or 1000; stand 802 is stand 606; and moveable mount 804 is moveable mount 608 or moveable mount 1002.

At FIG. 8B, computer system 800 detects input 850 (e.g., a tap and/or other input) selecting camera application icon 808. As illustrated in FIG. 8C, in response to detecting input 850 selecting camera application icon 808, computer system 800 displays camera application user interface 810. Camera application user interface 810 indicates a variety of available camera modes (e.g., video, photo, portrait, lapse, and/or slow-motion). In FIG. 8C, the camera mode is set to video (e.g., as indicated by the video option being centered and bolded compared to the other options) such that computer system 800 will capture and record videos. Camera application user interface 810 includes record control 812. At FIG. 8C, computer system 800 detects input 852 (e.g., a tap and/or other input) on record control 812.

As illustrated in FIG. 8D, in response to detecting input 852 on record control 812, computer system 800 initiates a process to capture video using one or more camera sensors. Field of view 814 (e.g., indicated by the broken line in the top of FIG. 8D) represents the field of view of the one or more camera sensors and/or the portion of the field of view of the one or more camera sensors displayed on display 806. During the process to capture video using the one or more camera sensors, the camera application records video within field of view 814. In FIG. 8D, computer system 800 displays video of field of view 814 and/or a portion of field of view 814 on display 806, along with record indicator 816, which indicates that video is being captured.

In some embodiments, the process for capturing video uses different logic when computer system 800 is on stand 802 than when computer system 800 is on moveable mount 804. For example, in response to detecting input 852 on record control 812, and in accordance with a determination that computer system 800 is connected to moveable mount 804, computer system 800 initiates a process to capture video according to a respective subject tracking mode of operation. In this case, initiating a process to capture video according to the respective subject tracking mode of operation includes using logic for tracking a subject, such as by physically moving and/or zooming computer system 800 and/or the one or more camera sensors. In response to detecting input 852 on record control 812, and in accordance with a determination that computer system 800 is not connect to moveable mount 804, computer system 800 initiates a process to capture video without enabling the respective subject tracking mode of operation. In this case, initiating a process to capture video without enabling the respective subject tracking mode of operation includes different logic for tracking a subject, such as by digitally moving and/or zooming the one or more camera sensors (e.g., without physically moving and/or zooming computer system 800 and/or the one or more camera sensors).

At FIG. 8E, computer system 800 is on stand 802 and the respective subject tracking mode of operation is not enabled. In the example shown, first person 840a gazes toward an object of interest (e.g., a whiteboard). Because the respective subject tracking mode of operation is not enabled, field of view 814 remains unchanged and only a portion of the whiteboard is visible in field of view 814.

At FIG. 8F, computer system 800 is on stand 802 and the respective subject tracking mode of operation is not enabled. In the example shown, second person 840b approaches first person 840a. Although first person 840a gazes towards second person 840b, because the respective subject mode of operation is not enabled, field of view 814 remains unchanged and second person 840b cannot be seen in field of view 814.

In FIG. 8G, first person 840a removes computer system 800 from stand 802 and places computer system 800 on moveable mount 804. In some embodiments, after computer system 800 was previously operated while not connected to moveable mount 804 and without the respective subject tracking mode of operation enabled, computer system 800 automatically enables the respective subject tracking mode of operation in accordance with (or in response to) a determination that computer system 800 is connected to moveable mount 804.

In some embodiments, computer system 800 causes output of an indication that the respective subject tracking mode of operation is enabled. In some embodiments, computer system 800 causes activation of an LED indicator (e.g., on moveable mount 804 and/or on computer system 800) in accordance with a determination that the respective subject tracking mode of operation is enabled. For example, computer system 800 causes the LED indicator to emit a blinking light in accordance with a determination that the respective subject tracking mode of operation is enabled and is actively being used to track a subject, such as first person 840a, and computer system 800 causes the LED indicator to emit a solid light in accordance with a determination that the respective subject tracking mode of operation is enabled but is not actively being used to track a subject.

At FIG. 8H, computer system 800 is connected to moveable mount 804 and the respective subject tracking mode of operation is enabled. In the respective subject tracking mode of operation, computer system 800 adjusts field of view 814 of the one or more camera sensors and/or a displayed portion of field of view 814, sends tracking data to moveable mount 804, and/or moves moveable mount 804 to track one or more subjects (e.g., the user and/or an item of interest). In some embodiments, the respective subject tracking mode of operation tracks one particular subject (e.g., as opposed to a centroid approach that attempts to keep two or more subjects in the field of view when two or more subjects of interest are present).

In some embodiments, the particular subject tracked in the respective subject tracking mode of operation is the first person that is detected within field of view 814 at the time the respective subject tracking mode of operation is enabled. In some embodiments, the subject tracked in the respective subject tracking mode of operation is selected to be tracked based on detection of a face, such as by identifying facial features. In some embodiments, the subject tracked in the respective subject tracking mode of operation is selected to be tracked based on detection of a body, such as by identifying a torso and/or limbs. In some embodiments, the subject tracked in the respective subject tracking mode of operation is selected to be tracked based on one or more facial features associated with a particular person, such as facial features associated with the primary user of the device, a person who has been saved as a contact, and/or a person who has been previously identified by computer system 800.

In some cases, computer system 800 detects more than one subject within field of view 814 when the respective subject tracking mode of operation is enabled. In some embodiments, the particular subject tracked in the respective subject tracking mode of operation is tracked because the particular subject is the person closest to the center of field of view 814 when the respective subject tracking mode of operation is enabled. In some embodiments, the particular subject tracked in the respective subject tracking mode of operation is tracked because the particular subject is the person closest to the center of field of view 814 that is looking at the one or more camera sensors when the respective subject tracking mode of operation is enabled.

In the example shown in FIG. 8H, the respective subject tracking mode of operation tracks first person 840a because first person 840a was the first person detected within field of view 814 when computer system 800 was connected to moveable mount 804 and because the respective subject tracking mode of operation was enabled. In some embodiments, if the respective subject looks away from the camera and toward a person or place for a predetermined period of time (e.g., 1 second, 2 seconds, or 5 seconds), computer system 800 identifies the person or place as an object of interest. In FIG. 8H, first person 840a looks away from the one or more camera sensors and gazes toward an object of interest (e.g., a whiteboard). Because the respective subject tracking mode of operation is enabled, computer system 800 adjusts field of view 814, such as by causing moveable mount 804 to rotate, pan, tilt, and/or roll computer system 800, based on the gaze of first person 840a toward the object of interest (e.g., the white board). In FIG. 8H, for example, moveable mount 804 rotates and/or pans computer system 800 so that the full whiteboard becomes visible in field of view 814.

At FIG. 8I, computer system 800 is connected to moveable mount 804 and the respective subject tracking mode of operation is enabled. In the example shown, second person 840b approaches first person 840a and first person 840a gazes toward second person 840b. Because the respective subject tracking mode of operation is enabled, computer system 800 adjusts field of view 814, such as by causing moveable mount 804 to rotate, pan, tilt, and/or roll computer system 800, based on the gaze of first person 840a toward second person 840b. In FIG. 8H, for example, moveable mount 804 rotates and/or pans computer system 800 so that second person 840b becomes visible in field of view 814.

In some embodiments, after computer system identifies an item of interest and/or an additional subject to track, such as second person 840b, computer system 800 tracks (or causes to be tracked) the item of interest and/or the additional subject, such as second person 840b, in addition to tracking first person 840a. In some embodiments, second person 840b is identified as an additional person to track because first person 840a gazes towards second person 840b. In some embodiments, second person 840b is identified as an additional person to track because second person 840b faces towards and/or looks at the one or more camera sensors. When more than one subject is being tracked, computer system 800 adjusts the displayed portion of field of view 814, to the extent possible, to include all subjects. For example, in FIG. 8I, computer system 800 adjusts field of view 814 to include first person 840a, second person 840b, and the white board.

In some embodiments, computer system 800 causes the respective subject tracking mode of operation to track a particular subject (e.g., rather than zooming out so that multiple subjects are visible in field of view 814). As shown in FIG. 8J, when first person 840a moves away from the whiteboard and second person 840b, computer system 800 causes field of view 814 to adjust to track first person 840a (e.g., rather than zooming out so that first person 840a, the whiteboard, and second person 840b are all visible within field of view 814). In the example shown, computer system 800 causes moveable mount 804 to rotate and/or pan computer system 800 so that first person 840a continues to be centered in field of view 814.

In some circumstances, it is not physically possible for computer system 800 to adjust field of view 814 to include the respective subject and one or more identified objects of interest. For example, in the situation shown in FIG. 8K, it is not possible for field of view 814 to include first person 840a, second person 840b, and the white board based on the position of the one or more camera sensors, even if field of view 814 is zoomed out. In this case, computer system 800 continues to track first person 840a according to the respective subject tracking mode of operation and ceases adjusting the displayed portion of field of view 814 to include second person 840b and/or the whiteboard.

At FIG. 8K computer system 800 tracks first person 840a according to the respective subject tracking mode of operation, and first person 840a moves outside field of view 814. For example, first person 840a moves and computer system 800 is unable to adjust field of view 814 to keep first person 840a within field of view 814 (e.g., due to the speed of movement of first person 840a relative to the speed of computer system 800 adjusting field of view 814). In some embodiments, the respective subject tracking mode of operation causes computer system 800 to continue adjusting field of view 814 based on the last known trajectory of the subject. For example, if computer system 800 was adjusting field of view 814 to follow the movement of first person 840a in a particular direction, computer system 800 will continue adjusting field of view 814 in the same direction after first person 840a moves outside field of view 814 in an effort to relocate first person 840a within field of view 814.

In some embodiments, the respective subject tracking mode includes changing the displayed portion of field of view 814 based on one or more characteristics of movement by a subject being tracked, such as the amount of movement and/or the speed of movement of first person 840a. In some embodiments, if the movement satisfies a predetermined threshold (e.g., a predetermined distance and/or a predetermined velocity), computer system 800 changes the displayed portion of field of view 814. For example, computer system 800 changes the displayed portion of field of view 814 based on the movement of first person 840a from his position in FIG. 8I to his position in FIG. 8J. In some embodiments, if the movement does not satisfy a predetermined threshold, the displayed portion of the field of view remains unchanged. For example, computer system 800 does not change the displayed portion of field of view 814 based on first person 840a talking and/or making hand gestures but otherwise staying in the general position shown in FIG. 8G.

FIG. 8L illustrates that computer system 800 continues adjusting field of view 814 along the trajectory that first person 840a was moving when first person 840a moved outside field of view 814. Because first person 840a continued moving in the same direction and computer system 800 adjusted field of view 814 in the same direction, computer system 800 relocates first person 840a within field of view 814, as shown in FIG. 8L.

In some embodiments, moveable mount 804 has one or more movement limits and, upon reaching a movement limit, computer system 800 cannot adjust field of view 814 beyond that movement limit. For example, moveable mount 804 cannot rotate (e.g., around a vertical axis) more than 360 degrees in total. From a starting position of 0 degrees, moveable mount 804 can rotate 180 degrees in the clockwise direction and 180 in the counterclockwise direction. Once the moveable mount reaches 180 degrees in either direction, a movement limit is reached and moveable mount 804 cannot move further in that direction. As another example, moveable mount 804 cannot move beyond a predetermined elevation angle. As illustrated in FIG. 8M, first person 840a moved beyond a movement limit of moveable mount 804, first person 840a is outside field of view 814, and moveable mount 804 cannot physically move the one or more camera sensors so that first person 840a is within field of view 814 of the one or more camera sensors.

In certain circumstances, computer system 800 is unable to relocate the subject within field of view 814. One example is when the subject moves beyond a movement limit, as described with respect to FIG. 8M. Another example is when a subject moves outside field of view 814 (e.g., moves with a velocity that is faster than computer system 800 is capable of moving (or configured to move) to track the subject), as described with respect to FIG. 8K, and computer system 800 is unable to detect the trajectory along which the subject moved. In some embodiments, tracking of a subject will “time out” (e.g., computer system 800 will cease tracking or attempting to track a respective subject) if the subject is not located within a predetermined period of time.

In some embodiments, when tracking of a subject times out (e.g., the subject has been outside the field of view for a predetermined period of time), computer system 800 causes field of view 814 to remain in the position that it was in when the subject was lost. At FIG. 8M, first person 840a moves outside field of view 814. After first person 840a has been outside field of view 814 for the predetermined period of time, tracking of first person 840a times out and field of view 814 remains unchanged (e.g., remains in the current position and size).

In some embodiments, when tracking of a subject times out (e.g., the subject has been outside the field of view for a predetermined period of time), computer system 800 causes the respective subject tracking mode of operation to change from tracking a first subject to tracking a second subject. At FIG. 8M, first person 840a moves and is outside field of view 814 for the predetermined period of time. As a result, at FIG. 8N, according to the respective subject tracking mode of operation, computer system 800 tracks the second subject (e.g., second person 840b).

In some embodiments, the second subject is determined to be the person closest to the center of the frame when the first subject has been outside field of view 814 for the predetermined period of time. In some embodiments, the second subject was previously identified within field of view 814. For example, in FIG. 8N, computer system 800 tracks second person 840b because second person 840b was previously identified in field of view 814, as illustrated in FIG. 8I. In some embodiments, computer system 800 causes field of view 814 to adjust to the last known location of a second subject. For example, as shown in FIG. 8N, computer system 800 causes field of view 814 to adjust to the location at which second person 840b had previously been identified.

In certain circumstances, after computer system 800 has been tracking second person 840b according to the respective subject tracking mode of operation, second person 840b moves outside field of view 814. For example, second person 840b moves outside field of view 814 when second person 840b moves beyond a movement limit, as discussed with respect to FIG. 8M. As another example, second person 840b moves outside field of view 814 when second person 840b moves with a velocity that is faster than computer system 800 is capable of moving (or configured to move) to track the subject and computer system 800 is unable to detect the trajectory along which second person 840b moved, as described with respect to FIG. 8K. In some embodiments, when tracking of second person 840b times out (e.g., the second person has been outside the field of view for a predetermined period of time), computer system 800 stops tracking second person 840b and resumes tracking first person 840a by scanning the last known location of first person 840a and/or a probable trajectory of first person 840a.

In some embodiments, computer system 800 includes two or more camera sensors. If computer system 800 is initially using first camera sensor 818 and the subject moves outside field of view 814, computer system 800 changes to begin using second camera sensor 820 to track the subject. For example, in FIG. 8O, first person 840a moves outside field of view 814 and moveable mount 814 has reached a movement limit. As a result, computer system 800 is no longer able use first camera sensor 818 to track first person 840a. As illustrated in FIG. 8P, computer system 800 changes from using first camera sensor 818 to using second camera sensor 820. First person 840a is within field of view 822 of second camera sensor 820 and, as a result, computer system 800 is able to track the user using second camera sensor 820.

FIG. 9 is a flow diagram illustrating a method for initiating a process to capture video with one or more camera sensors using a computer system in accordance with some embodiments. Method 900 is performed at a computer system (e.g., 100, 300, 500, 600, 800, 1000, a smartphone, a tablet computer, a laptop computer, a desktop computer, a smartwatch, a camera device, and/or an electronic control system) that is in communication with one or more camera sensors (e.g., 818 and/or 820). Some operations in method 900 are, optionally, combined, the orders of some operations are, optionally, changed, and some operations are, optionally, omitted.

As described below, method 900 provides an intuitive way for initiating a process to capture video with one or more camera sensors. The method reduces the cognitive burden on a user for initiating a process to capture video with one or more camera sensors, thereby creating a more efficient human-machine interface. For battery-operated computing devices, enabling a user to initiate a process to capture video with one or more camera sensors faster and more efficiently conserves power and increases the time between battery charges.

In some embodiments, the computer system detects (902) a request to capture video with the one or more camera sensors of the computer system. In some embodiments, in response to detecting the request to capture the video (904) (e.g., 850 and/or 852): in accordance with a determination that the computer system is connected to (e.g., physically connected to, physically mounted on, and/or in communication with via a wired or wireless connection) a moveable mount (e.g., 804) (e.g., in accordance with (or, in some embodiments, in response to) a determination that the computer system is connected to the moveable mount), the computer system initiates (906) a process to capture video with the one or more camera sensors of the computer system according to a respective subject tracking mode of operation (e.g., the visible portion of the field of view changes (e.g., is adjusted mechanically and/or electronically) based on a detected change within the field of view, such as movement of one or more subjects in the field of view (e.g., the field of view is adjusted to follow a subject that moves from one location to another)). In some embodiments, the respective subject tracking mode of operation causes the moveable mount to move based on a detected change within the field of view. In some embodiments, the computer system enables the respective subject tracking mode of operation in accordance with (or, in some embodiments, in response to) a determination that the computer system is connected to the moveable mount.

In some embodiments, in response to detecting the request to capture the video (904): in accordance with a determination that the computer system is not connected to (e.g., not physically connected to, not physically mounted on, and/or not in communication with via a wired or wireless connection) a moveable mount (e.g., a mount that is configured to physically hold or support the computer system, via gravity, a magnetic mechanism, and/or a mechanical mechanism), the computer system initiates (908) a process to capture video with the one or more camera sensors without enabling (e.g., without turning on and/or without operating according to) the respective subject tracking mode of operation. (e.g., without changing a visible portion of a field of view of one or more camera sensors based on a detected change in the field of view, such as movement of one or more users in the field of view). Automatically initiating a process to capture video according to a respective subject tracking mode of operation when the comnputer system is connected to a moveable mount reduces the number of inputs required to initiate the process to capture video in the respective subject tracking mode and allows the user to capture video in the respective subject tracking mode without displaying additional controls, which performs an operation when a set of conditions has been met without requiring further user input, reduces the number of inputs needed to perform an operation, and provides additional control options without cluttering the user interface with additional displayed controls.

In some embodiments, the mount has motors and/or controls that enable rotation, panning (e.g., rotation around a vertical axis), tilting (e.g., rotation around a horizontal axis), and/or rolling (e.g., rotation around a second horizontal axis perpendicular to the horizontal axis and the vertical axis) of one or more portions of the mount. In some embodiments, the respective subject tracking mode of operation includes causing the moveable mount to move (e.g., to rotate around one or more axes) in order to change the field of view of one or more camera sensors of the computer system to track one or more subjects (e.g., to keep the one or more users in the visible portion of the field of view). In some embodiments, when the respective subject tracking mode is enabled, the computer system tracks (e.g., digitally via image processing) one or more subjects in the field of view of the one or more camera sensors and/or sends instructions (e.g., via wireless communication) for the mount to move in order to move the computer system and change the field of view of one or more camera sensors of the computer system to keep the one or more users in the visible portion of the field of view. In some embodiments, the moveable mount is configured to move according to the instructions from the computer system. In some embodiments, operating the video capture user interface without enabling the respective subject tracking mode of operation includes operating the video capture user interface according to a second subject tracking mode that is different from the respective subject tracking mode (e.g., with the second subject tracking mode enabled and without the respective subject tracking mode enabled). In some embodiments, operating the video capture user interface without enabling the respective subject tracking mode of operation includes digitally changing (e.g., translating and/or zooming) a displayed portion of the field of the one or more camera sensors without causing the mount to move.

In some embodiments, after capturing video with the one or more camera sensors, with the computer system not connected to the moveable mount and without the respective subject tracking mode of operation enabled, the computer system receives an indication that the computer system is connected to the moveable mount. In some embodiments, in response to receiving the indication that the computer system is connected to the moveable mount, the computer system enables the respective subject tracking mode of operation (e.g., as described with reference to FIG. 8G) (e.g., tracking is automatically enabled when the computer system is connected to the moveable mount after the computer system was previously operated, while the computer system was disconnected from the moveable mount, without using the respective tracking mode). Automatically enabling a respective subject tracking mode of operation when the computer system is connected to the moveable mount after the computer system had previously been capturing video while the computer system was not connected to the moveable mount and without the respective subject tracking mode enabled reduces the number of inputs required to transition from capturing video without the respective subject tracking mode enabled to capturing video with the respective subject tracking mode enabled, thereby performing an operation when a set of conditions has been met without requiring further user input and reducing the number of inputs needed to perform an operation.

In some embodiments, capturing video with the one or more camera sensors according to the respective subject tracking mode of operation includes capturing video using a first algorithm (e.g., as described with reference to FIGS. 8G-8P) (e.g., an algorithm that includes logic for tracking one subject, such as by physically moving and/or zooming). In some embodiments, capturing video with the one or more camera sensors without enabling the respective subject tracking mode of operation includes capturing video using a second algorithm (e.g., as described with reference to FIGS. 8C-8F) (e.g., an algorithm that does not include logic for tracking a subject, an algorithm that includes logic for tracking multiple subjects, and/or an algorithm that includes logic for tracking one or more subjects by digitally moving and/or zooming) that is different from the first algorithm (and, ISE, without using the first algorithm). In some embodiments, the first algorithm and the second algorithm include different logic for tracking one or more subjects at different speeds. In some embodiments, the first algorithm and the second algorithm include different logic for centering one or more subjects in the field of view of the one or more camera sensors. In some embodiments, the first algorithm tracks one primary subject, while the second algorithm tracks one or more subjects that are identified within the field of view of the one or more camera sensors. In some embodiments, the first algorithm primarily tracks a first subject and tracks a second subject as an item of interest, while the second algorithm tracks a first subject and second subject in the same manner. Using a first algorithm when capturing video according to the respective subject tracking mode of operation and a second algorithm when capturing video without enabling the respective subject tracking mode of operation enables the computer system to use improved settings for capturing video and tracking a subject, when available, thereby performing an operation when a set of conditions has been met without requiring further user input and reducing the number of inputs needed to perform an operation.

In some embodiments, a first subject (e.g., 840a) (e.g., a first person) and a second subject (e.g., a second person) (e.g., 840b) are within a field of view of the one or more camera sensors. In some embodiments, while capturing video with the one or more camera sensors according to the respective subject tracking mode of operation, in response to detecting movement of the first subject (e.g., movement of first person 840a from his position in FIG. 8I to his position in FIG. 8J) (e.g., the first subject moves away from the second subject, such that the computer system cannot (or, in some embodiments, does not) change the field of view of the one or more camera sensors to include both the first subject and the second subject), the computer system tracks the movement of the first subject (e.g., adjusts the field of view of the one or more camera sensors to maintain the first subject in the field of view and/or in a portion (e.g., center) of the field of view). In some embodiments, the first subject and the second subject are within a field of view of the one or more camera sensors, and the respective subject tracking mode of operation causes the field of view of the one or more camera sensors to change based on (e.g., in response to and/or in accordance with) movement of the first subject without changing the field of view of the one or more camera sensors based on movement of the second subject. In some embodiments, when the respective subject tracking mode of operation is disabled (e.g., the computer system is not operating according to the respective subject tracking mode of operation), the field of view of the one or more camera sensors does not change based on movement of the first subject. Tracking the movement of a first subject upon detection that the first person moved enables the computer system to track the movement of the first subject without requiring additional input from a user and allows the computer system to track a particular subject when there are two subjects within the field of view, thereby performing an operation when a set of conditions has been met without requiring further user input and reducing the number of inputs needed to perform an operation.

In some embodiments, while capturing video with the one or more camera sensors according to the respective subject tracking mode of operation, in accordance with a determination that a gaze of a first subject (e.g., a first person) is directed to (e.g., has moved to) an item of interest (e.g., a second person and/or an object, such as a whiteboard) (e.g., the gaze of first person 840a toward the whiteboard shown in FIG. 8H and/or the gaze of first person 840a toward second person 840b shown in FIG. 8I), the computer system changes the field of view (e.g., 814) of the one or more camera sensors to include the item of interest (e.g., the whiteboard and/or second person 840b shown in FIG. 8I) (and/or, in some embodiments, such that the item of interest is in a predetermined portion (e.g., a central portion) of the field of view). In some embodiments, while the respective subject tracking mode of operation is enabled, the computer system changes the field of view of the one or more camera sensors based on the gaze of a first person to an item of interest, such that the field of view includes the item of interest. In some embodiments, as a result of the computer system changing the field of view to include the item of interest, the subject is farther from a center of the field of view than when a gaze of the subject is not directed to an item of interest (e.g., at an edge of the field of view of the one or more camera sensors) and/or partially out of the view of the field of view of the one or more camera sensors. Automatically changing the field of view of the camera sensor(s) to include an item of interest in accordance with a determination that the first subject gazed toward the item of interest reduces the number of inputs required to adjust the field of view, thereby performing an operation when a set of conditions has been met without requiring further user input and reducing the number of inputs needed to perform an operation.

In some embodiments, while capturing video with the one or more camera sensors according to the respective subject tracking mode of operation, in response to detecting movement of a first subject (e.g., a first person) (e.g., movement of first person 840a from his position in FIG. 8I to his position in FIG. 8J), the computer system changes the field of view of the one or more camera sensors to track the first subject without changing a zoom level of (e.g., without zooming in or out to enlarge or reduce an angular extent of) the field of view of the one or more camera sensors. In some embodiments, while the respective subject tracking mode of operation is enabled, the computer system changes the field of view of the one or more camera sensors based on movement of the first subject without changing the zoom level of the field of view of the one or more camera sensors based on movement of a second subject (e.g., the field of view of the one or more camera sensors shifts, translates, and/or pans to track the first subject instead of zooming in or out). Changing the field of view of the camera sensor(s) to track a first subject in response to detecting that the first subject has moved without zooming out enables the computer system to maintain the image quality and/or the size of the first subject within the field of view while continuing to track the first subject, thereby performing an improved operation when a set of conditions has been met without requiring further user input and reducing the number of inputs needed to per-form an operation.

In some embodiments, while capturing video with the one or more camera sensors according to the respective subject tracking mode of operation, in accordance with a determination that a first subject (e.g., a first person) has moved outside the field of view of the one or more camera sensors (e.g., movement of first person 840a in FIG. 8K to be outside field of view 814), the computer system changes the field of view of the one or more camera sensors based on a trajectory (e.g., path, direction, and/or speed) of the first subject (e.g., the direction of movement of first person 840a from his position in FIG. 8J to his position in FIG. 8K) (e.g., the last known path of movement of the first subject and/or an estimated future path of movement of the first subject). In some embodiments, while the respective subject tracking mode of operation is enabled, the computer system changes the field of view of the one or more camera sensors based on the last known trajectory of the first subject (e.g., the computer system changes the field of view of the camera sensor to follow the path of movement the first subject was taking) when the first subject moved outside the field of view of the one or more camera sensors. Changing the field of view of the camera sensor(s) based on the trajectory of the first subject, in accordance with a determination that the first subject moved outside the field of view, enables the computer system to attempt to relocate the subject in the field of view, thereby performing an improved operation when a set of conditions has been met without requiring further user input and reducing the number of inputs needed to perform an operation.

In some embodiments, while capturing video with the one or more camera sensors according to the respective subject tracking mode of operation, in accordance with a determination that the first subject has been outside the field of view of the one or more camera sensors for a predetermined period of time (e.g., first person 840a being outside field of view 814 in FIG. 8M for a predetermined time), the computer system maintains (e.g., stops changing) the field of view of the one or more camera sensors (e.g., field of view 814 in FIG. 8M). In some embodiments, while the respective tracking mode of operation is enabled, the computer system maintains (e.g., stops changing) the field of view of the one or more camera sensors in accordance with a determination that the first subject is outside the field of view of the one or more camera sensors for a predetermined period of time (e.g., the respective subject tracking mode of operation times out if the first subject is not found within a predetermined period of time). In some embodiments, while the respective subject tracking mode of operation is enabled, the computer system changes the field of view to a home position and maintains the home position when the first subject is lost. In some embodiments, while the respective subject tracking mode of operation is enabled, the computer system maintains the field of view at the time the first subject was lost. Maintaining the field of view of the camera sensor(s) after the first subject has been outside the field of view for a predetermined period of time enables the computer system to conserve resources rather than continue attempting to locate the first subject when it has become unlikely that the computer system will be able to do so, thereby performing an improved operation when a set of conditions has been met without requiring further user input and reducing the number of inputs needed to perform an operation.

In some embodiments, the computer system includes two or more camera sensors (e.g., 818 and 820) (e.g., a camera sensor on the front of the computer system and a camera sensor on the back of the computer system). In some embodiments, the computer system captures video with the first camera sensor of the two or more camera sensors (e.g., with the camera sensor on the front of the computer system) according to the respective subject tracking mode of operation, including tracking movement of a first subject (e.g., a first person) based on video captured by the first camera sensor (e.g., 818 or 820). In some embodiments, in accordance with a determination that the first subject is (e.g., has moved) outside the field of view of the first camera sensor of the two or more camera sensors (e.g., outside the field of view of the camera sensor on the front of the computer system) and the first subject is within the field of view of a second camera sensor (e.g., 820 or 818) of the two or more camera sensors (e.g., within the field of view of the camera sensor on the back of the computer system), the computer system captures video with the second camera sensor of the two or more camera sensors (e.g., with the camera sensor on the back of the computer system) according to the respective subject tracking mode of operation (e.g., in order to continue tracking the first person based on video captured by the second camera sensor). Capturing video with a second camera after the first subject has been outside the field of view of the first camera for a predetermined period of time enables the computer system to switch camera sensors rather than continuing to attempt to locate the first subject with the first camera when it has become unlikely that the computer system will be able to do so, thereby performing an improved operation when a set of conditions has been met without requiring further user input and reducing the number of inputs needed to perform an operation.

In some embodiments, the computer system captures video with the one or more camera sensors according to the respective subject tracking mode of operation, including tracking movement of a first subject (e.g., a first person) in accordance with a determination that the first subject is a first person (e.g., an initial person) detected in the field of view of the one or more camera sensors when the respective subject tracking mode of operation is enabled (e.g., first person 840a is detected in field of view 814 when the respective subject tracking mode of operation is enabled in FIG. 8G). Tracking movement of a first subject based on the first subject being the first person detected in the field of view enables the computer system to automatically identify a subject to track, thereby performing an operation when a set of conditions has been met without requiring further user input and reducing the number of inputs needed to perform an operation.

In some embodiments, the computer system captures video with the one or more camera sensors according to the respective subject tracking mode of operation, including tracking movement of a first subject (e.g., a first person), wherein the first subject is tracked (or, in some embodiments, is selected for tracking) (at least in part) based on a detection of a face (e.g., the detection of one or more facial features, such as eyes, nose, mouth, and/or face shape) of the first subject when the respective subject tracking mode of operation is enabled (e.g., tracking movement of the first subject is performed in accordance with a determination that a face of the first subject is detected). In some embodiments, the first subject is not tracked if a face of the first subject is not detected. Tracking movement of a first subject based on detection of a face enables the computer system to automatically identify a relevant subject to track, thereby performing an operation when a set of conditions has been met without requiring further user input and reducing the number of inputs needed to perform an operation.

In some embodiments, the computer system captures video with the one or more camera sensors according to the respective subject tracking mode of operation, including tracking movement of a first subject (e.g., a first person), wherein the first subject is tracked (or, in some embodiments, is selected for tracking) (at least in part) based on a detection of a body (e.g., the detection of a torso and/or one or more limbs) of the first subject when the respective subject tracking mode of operation is enabled (e.g., tracking movement of the first subject is performed in accordance with a determination that a body of the first subject is detected). In some embodiments, the first subject is not tracked if a body of the first subject is not detected. Tracking movement of a first subject based on detection of a body enables the computer system to automatically identify a relevant subject to track, thereby performing an operation when a set of conditions has been met without requiring further user input and reducing the number of inputs needed to perform an operation.

In some embodiments, the computer system captures video with the one or more camera sensors according to the respective subject tracking mode of operation, including tracking movement of a first subject (e.g., a first person). In some embodiments, the first subject is tracked (or, in some embodiments, selected for tracking) (at least in part) based on a detection of one or more facial features (e.g., eyes, nose, mouth, and/or face shape) of a known subject (e.g., a primary user of the computer system, a contact, and/or person previously identified by the computer system) when the respective subject tracking mode of operation is enabled (e.g., tracking movement of the first subject is performed in accordance with a determination that one or more facial features of a known subject is detected). In some embodiments, the first subject is not tracked if one or more facial features of a known subject are not detected. Tracking movement of a first subject based on detection of one or more facial features of a known subject enables the computer system to automatically identify a relevant subject to track, thereby performing an operation when a set of conditions has been met without requiring further user input and reducing the number of inputs needed to perform an operation.

In some embodiments, the computer system captures video with the one or more camera sensors according to the respective subject tracking mode of operation, including tracking movement of a first subject (e.g., a first person). In some embodiments, the first subject is tracked (or, in some embodiments, is selected for tracking) (at least in part) based on the first subject being a person that is closest to the center of the field of view of the one or more camera sensors when the respective subject tracking mode of operation is enabled. Tracking movement of a first subject based on the first subject being the person closest to the center of the field of view enables the computer system to automatically identify a relevant subject to track, thereby performing an operation when a set of conditions has been met without requiring further user input and reducing the number of inputs needed to perform an operation.

In some embodiments, the computer system captures video with the one or more camera sensors according to the respective subject tracking mode of operation, including tracking movement of a first subject (e.g., a first person). In some embodiments, the first subject is tracked (or, in some embodiments, selected for tracking) (at least in part) based on the first subject being a person that is closest to the center of the field of view of the one or more camera sensors and is looking at (e.g., facing and/or directing eye contact towards) the one or more camera sensors when the respective subject tracking mode of operation is enabled. Tracking movement of a first subject based on the first subject being the person closest to the center of the field of view and looking at the one or more camera sensors enables the computer system to automatically identify a relevant subject to track, thereby performing an operation when a set of conditions has been met without requiring further user input and reducing the number of inputs needed to perform an operation.

In some embodiments, a first subject (e.g., a first person) and a second subject (e.g., a second person) are within the field of view of the one or more camera sensors. In some embodiments, the computer system captures video with the one or more camera sensors according to the respective subject tracking mode of operation, including tracking (e.g., tracking movement of) the first subject. In some embodiments, after tracking the first subject, in accordance with a determination that the first subject is (e.g., has moved) outside the field of view of the one or more camera sensors for a predetermined period of time (e.g., 0.1 seconds, 0.2 seconds, 0.5 seconds, 1 second, 2 seconds, 3 seconds, 5 seconds, 10 seconds, 15 seconds, 60 seconds, or 120 seconds), the computer system changes the field of view of the one or more camera sensors based on a position of the second subject (e.g., field of view 814 in FIG. 8N based on the position of second person 840b) (e.g., adjusts the field of view to be centered on the second subject and/or switches from tracking the first subject to tracking the second subject based on the first subject having been outside the field of view of the one or more camera sensors for a predetermined period of time). Changing the field of view of the camera sensor(s) based on the position of a second subject enables the computer system to automatically transition to tracking the second subject after the first subject has been outside the field of view for a predetermined period of time, thereby performing an improved operation when a set of conditions has been met without requiring further user input and reducing the number of inputs needed to perform an operation.

In some embodiments, the field of view of the one or more camera sensors is changed based on the position associated with the second subject in accordance with (at least in part) a determination that the second subject is a person that closest to the center of the field of view of the one or more camera sensors at the time of the determination that the first subject is outside the field of view of the one or more camera sensors for the predetermined period of time (e.g., if first person 840a leaves field of view 814 shown in FIG. 8I, the second subject is determined to be second person 840b since second person 840b is the subject closest to center of field of view 814 at the time first person 840a is determined to be outside field of view 814 for the predetermined time and, as a result, computer system 800 will track second person 840b, as shown in FIG. 8N). Tracking movement of a second subject based on the second subject being the person closest to the center of the field of view enables the computer system to automatically identify a second subject to track when the first subject has been outside the field of view for a predetermined period of time, thereby performing an operation when a set of conditions has been met without requiring further user input and reducing the number of inputs needed to perform an operation.

In some embodiments, the field of view of the one or more camera sensors is changed based on the position associated with the second subject in accordance with (e.g., based at least in part on) a determination that the second subject is a person that was previously identified within the field of view of the one or more camera sensors (e.g., second person 840b in FIG. 8N was previously identified in field of view 814 in FIG. 8I) (e.g., the first person looked at the second person). In some embodiments, the second subject was previously identified because the second subject looked at (e.g., faced towards and/or made eye contact with) the one or more camera sensors. Tracking movement of a second subject based on the second subject being a person that was previously identified within the field of view enables the computer system to automatically identify a second subject to track when the first subject has been outside the field of view for a predetermined period of time, thereby performing an operation when a set of conditions has been met without requiring further user input and reducing the number of inputs needed to perform an operation.

In some embodiments, the position associated with the second subject is a last known location of the second subject (e.g., the position of second person 840b in FIG. 8I was previously known, therefore it is the position associated with second person 840b in FIG. 8N). Changing the field of view of the camera sensor(s) to the last know location of a second subject enables the computer system to automatically attempt to locate the second subject in the field of view after a first subject has been outside the field of view for a predetermined period of time, thereby performing an operation when a set of conditions has been met without requiring further user input and reducing the number of inputs needed to perform an operation.

In some embodiments, after changing the field of view of the one or more camera sensors based on a position of the second subject: in accordance with a determination that the second subject is (e.g., has moved) outside the field of view of the one or more camera sensors for a predetermined period of time (e.g., 0.1 seconds. 0.2 seconds, 0.5 seconds, 1 second, 2 seconds, 3 seconds, 5 seconds, 10 seconds, 60 seconds, or 120 seconds), the computer system changes the field of view of the one or more camera sensors based on a position of the first subject (e.g., adjust the field of view to be centered on the first subject and/or switch from tracking the second subject to tracking the first subject based on the second subject having been outside the field of view of the one or more camera sensors for a predetermined period of time). Changing the field of view of the camera sensor(s) based on the position of the first subject enables the computer system to automatically transition to tracking the first subject after the second subject has been outside the field of view for a predetermined period of time, thereby performing an improved operation when a set of conditions has been met without requiring further user input and reducing the number of inputs needed to perform an operation.

In some embodiments, the computer system captures video with the one or more camera sensors according to the respective subject tracking mode of operation, including tracking a first subject. In some embodiments, in accordance with a determination that the moveable mount reaches a movement limit (e.g., rotated position of moveable mount 804 in FIG. 8M) (e.g., a minimum position limit or a maximum position limit; and/or the moveable mount cannot physically move further), the computer system ceases tracking the first subject (e.g., ceases to change the field of view of the one or more camera sensors to track the first subject, optionally by maintaining the field of view of the one or more camera sensors, by changing the field of view of the one or more camera sensors to track a different subject, or by changing the field of view of the one or more camera sensors to a different position that is selected based on other criteria such as a default or neutral position). In some embodiments, while the respective subject tracking mode of operation is enabled, the computer system maintains (e.g., stops changing) the field of view of the one or more camera sensors if the moveable mount meets a movement limit threshold. In some embodiments, when the moveable mount reaches a movement limit and can no longer mechanically change the field of view of the one or more camera sensors, the computer system continues tracking the first subject by digitally changing the field of view of the one or more camera sensors. Ceasing to track the first subject when the moveable mount reaches a movement limit enables the computer system to automatically cease tracking when tracking is no longer possible, thereby performing an operation when a set of conditions has been met without requiring further user input and reducing the number of inputs needed to perform an operation.

In some embodiments, while capturing video with the one or more camera sensors of the computer system according to the respective subject tracking mode of operation, in accordance with a determination that one or more characteristics (e.g., distance, amount, and/or speed) of movement of a respective subject satisfy a first criteria (e.g., a predetermined distance threshold, amount threshold, and/or speed threshold), the computer system changes the displayed field of view of the one or more camera sensors. In some embodiments, while capturing video with the one or more camera sensors of the computer system according to the respective subject tracking mode of operation, in accordance with a determination that the one or more characteristics of movement of the respective subject does not satisfy the first criteria, the computer system maintains (e.g., does not change) the displayed field of view of the one or more camera sensors. In some embodiments, changes to the displayed field of view are proportional to the movement of the respective subject (e.g., the displayed field of view is changed quickly if the respective subject moves quickly). In some embodiments, the displayed field of view is maintained (e.g., not changed) or is changed slowly based on small movements of the respective subject (e.g., making hand gestures and/or moving limbs). In some embodiments, the displayed field of view of the one or more camera sensors is changed quickly based on large and/or substantial movements of the respective subject (e.g., moving from one location to another location and/or moving throughout a space). In some embodiments, the displayed field of view is maintained (e.g., not changed) or is changed a small amount based on small movements of the respective subject (e.g., making hand gestures and/or moving limbs). In some embodiments, the displayed field of view of the one or more camera sensors is substantially changed based on large and/or substantial movements of the respective subject (e.g., moving from one location to another location and/or moving throughout a space). Changing a displayed field of view based on one or more characteristics of movement by a respective subject enables the computer system to efficiently track the respective subject without requiring additional input from a user, thereby performing an improved operation when a set of conditions has been met without requiring further user input and reducing the number of inputs needed to perform an operation.

In some embodiments, while capturing video with the one or more camera sensors of the computer system according to the respective subject tracking mode of operation and after changing the displayed field of view of the one or more camera sensors in accordance with a determination that one or more characteristics (e.g., distance, amount, and/or speed) of movement of a respective subject satisfy the first criteria (e.g., a predetermined distance threshold, amount threshold, and/or speed threshold): in accordance with a determination that one or more characteristics (e.g., distance, amount, and/or speed) of movement of a respective subject satisfy a second predetermined criteria (e.g., a second predetermined distance threshold, amount threshold, and/or speed threshold), the computer system changes the displayed field of view of the one or more camera sensors. In some embodiments, while capturing video with the one or more camera sensors of the computer system according to the respective subject tracking mode of operation and after changing the displayed field of view of the one or more camera sensors in accordance with a determination that one or more characteristics (e.g., distance, amount, and/or speed) of movement of a respective subject satisfy the first criteria (e.g., a predetermined distance threshold, amount threshold, and/or speed threshold): in accordance with a determination that the one or more characteristics of movement of the respective subject does not satisfy the second predetermined criteria, the computer system maintains (e.g., does not change) the displayed field of view of the one or more camera sensors. Changing a displayed field of view in accordance with a determination that movement of the respective subject is above a predetermined threshold and maintaining the displayed field of view in accordance with a determination that the movement of the respective subject is below a predetermined threshold enables the computer system to track the respective subject more efficiently and without requiring additional input from a user, thereby performing an improved operation when a set of conditions has been met without requiring further user input and reducing the number of inputs needed to perform an operation.

In some embodiments, in accordance with a determination that the respective subject tracking mode of operation is enabled, the computer system causes output of an indication that the respective subject tracking mode of operation is enabled (e.g., causing activation of an LED indicator on the computer system and/or on the moveable mount and/or causing the computer system to send data indicating that the respective subject tracking mode of operation is enabled to the moveable mount). Causing output of an indication in accordance with a determination that the respective subject tracking mode of operation is enabled provides a user with an indication that the respective subject tracking mode of operation is enabled, thereby providing the user with improved visual feedback.

In some embodiments, causing the output of the indication that the respective subject tracking mode of operation is enabled includes, in accordance with a determination that the respective subject tracking mode of operation is active (e.g., the respective subject tracking mode of operation is enabled and is actively being used to track a respective subject), causing output of the indication with a first characteristic (e.g., a blinking and/or flashing LED indicator). Causing output of the indication with a first characteristic in accordance with a determination that the respective subject tracking mode of operation is active provides a user with an indication that the respective subject tracking mode of operation is active, thereby providing the user with improved visual feedback.

In some embodiments, causing the output of the indication that the respective subject tracking mode of operation is enabled includes, in accordance with a determination that the respective subject tracking mode of operation is not active (e.g., the respective subject tracking mode of operation is enabled and is not actively being used to track a respective subject), causing output of the indication with a second characteristic (e.g., a solid LED indicator) that is different from the first characteristic. Causing output of the indication with a second characteristic in accordance with a determination that the respective subject tracking mode of operation is not active provides a user with an indication that the respective subject tracking mode of operation is not active, thereby providing the user with improved visual feedback.

FIGS. 10A-10H illustrate exemplary techniques for animations performed with a moveable mount, in accordance with some embodiments. The animations and user interfaces in these figures are used to illustrate the processes described below, including the processes in FIG. 11.

FIG. 10A illustrates device 1000 and moveable mount 1002. In FIG. 10A, device 1000 is a smartphone with display 1004. In some embodiments, device 1000 is a tablet computer, a laptop computer, a desktop computer, a smartwatch, a camera device, and/or an electronic control system. In some embodiments, device 1000 is computer system 600 and/or 800; and moveable mount 1002 is moveable mount 608 or moveable mount 804. As shown in FIG. 10A, device 1000 is initially resting on a table.

At FIG. 10B, the user initiates a process associated with capturing video, such as placing device 1000 on moveable mount 1002. In some embodiments, the user places device 1000 on moveable mount 1002 after launching a camera application, such that device 1000 is operating the camera application when placed on moveable mount 1002. When the user initially connects device 1000 on moveable mount 1002, device 1000 is in no particular orientation.

At FIG. 10C, device 1000 is connected to moveable mount 1002 and device 1000 and/or moveable mount 1002 obtains an indication that a process associated with capturing video has been initiated, such as an indication that the camera application is operating. In response to obtaining the indication, moveable mount 1002 performs an animation. In the example shown in FIG. 10C, moveable mount 1002 moves device 1000 so that device 1000 is oriented towards the user. For example, depending on the original orientation in which device 1000 was placed on moveable mount 1002, moveable mount 1002 is caused (e.g., by device 1000 or other computer system in communication with device 1000 and/or moveable mount 1002) to raise, lower, and/or rotate so that device 1000 is oriented towards the user. In some embodiments, device 1000 is oriented towards the user in a landscape orientation, as shown in FIG. 10C. In some embodiments, device 1000 is oriented towards the user in a portrait orientation.

Moveable mount 1002 can perform different animations for different events. In FIG. 10C, the event includes an indication of the start of a process for capturing video, such as an indication that device 1000 has been connected to moveable mount 1002 and/or the camera application is operating, and the animation includes moving device 1000 toward the user. In some embodiments, the event includes an indication of the end of a process for capturing video, such as an indication that device 1000 has been disconnected from moveable mount 1002, that device 1000 has entered a low power mode, and/or the camera application is no longer operating. In this case, the resulting animation includes moving device 1000 so device 1000 is oriented downward.

At FIG. 10D, device 1000 enters a low power state. Device 1000 had previously been oriented towards the user, so device 1000 is oriented towards the user at the time device 1000 enters the low power state. For example, as illustrated in FIG. 10D, display 1004 of device 1000 dims to conserve power.

As illustrated by FIG. 10E, in response to obtaining an indication that device 1000 entered a low power state, moveable mount 1002 moves device 1000 so device 1000 is facing downward. As shown in FIG. 10E, moveable mount 1002 moves device 1000 so that device 1000 is facing toward the table.

At FIG. 10F, the user performs an action, such as speaking, that causes device 1000 to transition from the low power mode to a normal mode. For example, the user says, “Hey! Open the camera.” As a result, device 1000 changes from the low power mode to a normal operating mode and device 1000 displays camera application user interface 1006. In some embodiments, device 1000 changes from the low power mode to the normal operating mode and displays camera application user interface 1006 in response to one or more inputs by the user.

As illustrated by FIG. 10G, in response to obtaining an indication that device 1000 transitioned from the low power mode to the normal mode, moveable mount 1002 moves device 1000 so that device 1000 is oriented towards the user. In some embodiments, device 1000 is oriented towards the user based on the last known location of the user. For example, FIG. 10G illustrates device 1000 oriented to the position the user was previously located, such as in FIG. 10C.

In some embodiments, moveable mount 1002 orients device 1000 towards the user based on the location of audio, such as the location of the user's voice when instructing device 1000 to transition from the low power mode to the normal mode. FIG. 10H illustrates that moveable mount 1002 orients device 1000 in a different orientation than it had previously been based on the user's voice being projected from a different location.

FIG. 11 is a flow diagram illustrating a method for moving a device that is connected to a moveable mount using a computer system in accordance with some embodiments. Method 1100 is performed at a computer system (e.g., 100, 300, 500, 600, 800, 1000, a smartphone, a tablet computer, a laptop computer, a desktop computer, a smartwatch, a camera device, and/or an electronic control system) that is in communication with a moveable mount (e.g., 1002) (e.g., a mount that is configured to physically hold or support the computer system and/or a device via gravity, a magnetic mechanism, and/or a mechanical mechanism). Some operations in method 1100 are, optionally, combined, the orders of some operations are, optionally, changed, and some operations are, optionally, omitted.

As described below, method 1100 provides an intuitive way for moving a device that is connected to a moveable mount. The method reduces the cognitive burden on a user for moving a device that is connected to the moveable mount, thereby creating a more efficient human-machine interface. For battery-operated computing devices, enabling a user to move a device that is connected to the moveable mount faster and more efficiently conserves power and increases the time between battery charges.

In some embodiments, the computer system obtains (1102) (e.g., via the sensors of the electronic device and/or via a signal from the electronic device) an indication of an event associated with capturing video (e.g., an indication that device 1000 is connected to moveable mount 1002 in FIG. 10B), wherein the video is captured by a device (e.g., 1000) (e.g., a smartphone, one or more camera sensors, a tablet computer, and/or a smartwatch) that is connected to (e.g., physically connected to, physically mounted on, and/or in communication with via a wired or wireless connection) the moveable mount, and wherein the device that is connected to the moveable mount is moved, via the moveable mount, to track one or more objects (e.g., one or more users and/or one or more objects of interest) while the video is being captured (e.g., tracking movements of first person 840a in FIGS. 8A-8P). In some embodiments, device 1000 is also the computer system. In some embodiments, the computer system obtains an indication of an event not associated with capturing video (e.g., an event associated with playing a video without capturing a video). In some embodiments, the computer system is (or is included in) the device that is connected to the moveable mount. In some embodiments, the device is moved so a visible field of view of the video changes to follow a user that moves from one location to another. In some embodiments, the device has a rechargeable battery and, when the device is connected to the moveable mount, the moveable mount charges the battery (e.g., via wireless charging).

In some embodiments, in response to obtaining the indication of the event, the computer system causes (1104) the moveable mount to perform a sequence of one or more mechanical movements that move the device that is connected to the moveable mount (e.g., raising the device as shown from FIGS. 10B to 10C), wherein the sequence of one or more mechanical movements is associated with the event. In some embodiments, the device is the computer system. In some embodiments, performing the sequence of one or more mechanical movements that move the device includes changing an orientation of the device (e.g., raising, lowering, or orienting towards a user). In some embodiments, in response to obtaining the indication of the event, the computer system causes the device to perform an animation by, e.g., emitting a sound and/or vibrating (e.g., vibrating with a rhythm of music). Causing the moveable mount to perform a sequence of mechanical movements in response to obtaining an indication of an event provides a user with an indication that the event associated with the sequence of mechanical movements has occurred, thereby providing the user with improved visual feedback.

In some embodiments, causing the moveable mount to perform the sequence of the one or more mechanical movements includes, in accordance with a determination that the event corresponds to a first event, causing the moveable mount to perform a first sequence of one or more mechanical movements (e.g., raising as shown in FIG. 10C). In some embodiments, causing the moveable mount to perform the sequence of the one or more mechanical movements includes, in accordance with a determination that the event corresponds to a second event, causing the moveable mount to perform a second sequence of one or more mechanical movements (e.g., lowering as shown in FIG. 10D), wherein the second sequence of one or more mechanical movements is different from the first sequence of one or more mechanical movements (e.g., the first sequence of one or more mechanical movements and the second sequence of one or more mechanical movements include movements in different directions, at different speeds, with different magnitudes, and/or with different patterns). In some embodiments, the sequence of the one or more mechanical movements is based on the event (e.g., is different for different events). Causing the moveable mount to perform a first sequence of mechanical movements in response to obtaining an indication of a first event and a second sequence of mechanical movements in response to obtaining an indication of a second event provides the user with an indication of which event occurred, thereby providing the user with improved visual feedback.

In some embodiments, the device includes a camera sensor. In some embodiments, when the sequence of one or more mechanical movements is complete (e.g., at the end of the sequence of one or more mechanical movements), the camera sensor is oriented down (e.g., a camera sensor on the front of device 1000 is oriented down in FIG. 10E) (e.g., down relative to a direction of gravity, down relative to an orientation or configuration of the moveable mount, oriented away from a user, pointing towards a table, and/or pointing towards a floor). Causing the camera sensor to be oriented down when the sequence of one or more mechanical movements is completed provides the user with an indication that the sequence of mechanical movements is complete, thereby providing the user with improved visual feedback. When the sequence of one or more mechanical movements corresponds to an event associated with recording video, causing the camera sensor to be oriented down when the sequence of one or more mechanical movements is completed provides the user with increased privacy by clearly indicating that the video recording has stopped.

In some embodiments, the indication of the event includes an indication of a start of a process for capturing video with the device (e.g., as described with reference to FIG. 10B) (e.g., the sequence of one or more mechanical movement is performed when the process begins). In some embodiments, the indication of the event includes an indication of a connection of the connected device to the moveable mount and/or the connected device transitioning from a low power mode to a normal mode. Causing the moveable mount to perform a sequence of mechanical movements in response to obtaining an indication of the start of a process for capturing video with the device provides the user with an indication that the process for capturing video has started, thereby providing the user with improved visual feedback.

In some embodiments, the connected device includes a display generation component. In some embodiments, the sequence of one or more mechanical movements includes moving the connected device so a camera sensor of the device (and/or a display of the device) is oriented up (e.g., a camera sensor on the front of device 1000 is oriented up in FIG. 10D) (e.g., the display is oriented towards a user, such as in a portrait orientation relative to the user or a landscape orientation relative to the user). Causing the moveable mount to move the device so the display is oriented up in response to obtaining an indication of the start of a process for capturing video provides the user with an indication that the process for capturing video has started, thereby providing the user with improved visual feedback.

In some embodiments, the indication of the event includes an indication of an end of a process for capturing video with the device (e.g., the sequence of one or more mechanical movement is performed when the process ends). In some embodiments, the indication of the event includes an indication of a disconnection from the moveable mount and/or the connected device transitioning from a normal mode to a low power mode. Causing the moveable mount to perform a sequence of mechanical movements in response to obtaining an indication of the end of a process for capturing video with the device provides the user with an indication that the process for capturing video has ended, thereby providing the user with improved visual feedback. Causing the moveable mount to perform a sequence of mechanical movements in response to obtaining an indication of the end of a process for capturing video with the device also provides the user with increased privacy by clearly indicating that the process for capturing video has ended.

In some embodiments, the device includes a display generation component. In some embodiments, the sequence of one or more mechanical movements includes moving the device so a camera sensor of the device (and/or a display of the device) is oriented down (e.g., a camera sensor on the front of device 1000 is oriented down in FIG. 10E) (e.g., down relative to a direction of gravity, down relative to an orientation or configuration of the moveable mount, oriented away from a user, pointing towards a table, and/or pointing towards a floor). Causing the moveable mount to move the device so the display is oriented down in response to obtaining an indication of the end of a process for capturing video provides the user with an indication that the process for capturing video has ended, thereby providing the user with improved visual feedback. Causing the moveable mount to move the device so the display is oriented down in response to obtaining an indication of the end of a process for capturing video also provides the user with improved privacy benefits by clearly indicating that the process for capturing video has ended.

In some embodiments, the indication of the event includes an indication that the device transitioned from a low power mode (e.g., a sleep mode, a mode in which a display of the device is off or dimmed, and/or a mode in which a predetermined set of operations are stopped, suspended, or updated at a lower rate than during normal operation) to a normal mode (e.g., as described with reference to FIGS. 10E-10G) (e.g., a normal operating state, a non-low power mode, a mode in which a display of the device is on and/or not dimmed, and/or a mode in which the predetermined set of operations are being performed according to a standard operational mode). In some embodiments, the event includes a user touching or using the device. Causing the moveable mount to perform a sequence of mechanical movements in response to obtaining an indication that the device transitioned from a low power mode to a normal mode provides the user with an indication that the device changed modes, thereby providing the user with improved visual feedback.

In some embodiments, the device includes a display generation component. In some embodiments, the sequence of one or more mechanical movements includes moving the device so a camera sensor of the device (and/or a display of the device) is oriented toward a user (e.g., a camera sensor on the front of device 1000 is oriented towards a user) (e.g., in a portrait orientation relative to the user or in a landscape orientation relative to the user). Causing the moveable mount to orient towards a user in response to obtaining an indication that the device transitioned from a low power mode to a normal mode provides the user with an indication that the device changed modes, thereby providing the user with improved visual feedback.

In some embodiments, the camera sensor of the device (and/or a display of the device) is oriented towards the user based on a location of audio (e.g., based on the location of the sound “Hey! Open the camera.” in FIG. 10F and FIG. 10H) (e.g., based on the location of a subject's voice). In some embodiments, the event includes detection of the audio (e.g., the sequence of one or more mechanical movements is performed in response to detection of the audio). In some embodiments, in accordance with a determination that a source of the audio is at a first location, the moveable mount orients the device toward the first location; and in accordance with a determination that the source of the audio is at a second location that is different from the first location, the moveable mount orients the device toward the second location. Causing the moveable mount to orient towards a user based on a location of audio enables the computer system to locate the user, thereby performing an operation when a set of conditions has been met without requiring further user input and reducing the number of inputs needed to perform an operation.

In some embodiments, the camera sensor of the device (and/or a display of the device) is oriented towards the user based on a last known location of the user (e.g., the orientation of the camera sensor of device 1000 in FIG. 10G is based on the location of the man in FIG. 10C). In some embodiments, in accordance with a determination that the last known location of the user is a first location, the moveable mount orients the device toward the first location; and in accordance with a determination that the last known location is a second location that is different from the first location, the moveable mount orients the device toward the second location. Causing the moveable mount to orient towards a user based on the last known location of the user enables the computer system to locate the user, thereby performing an operation when a set of conditions has been met without requiring further user input and reducing the number of inputs needed to perform an operation.

In some embodiments, the indication of the event includes an indication that the device is capturing video (e.g., recording video and/or sharing video in a video call). In some embodiments, the device includes a display generation component. In some embodiments, the sequence of one or more mechanical movements includes moving the device so a display generation component of the device is oriented toward a user (e.g., moving device 1000 in accordance with the respective subject tracking mode of operation illustrated in FIGS. 8G-8P) (e.g., in a portrait orientation relative to the user or in a landscape orientation relative to the user). Causing the moveable mount to orient towards a user in response to obtaining an indication that the device is capturing video provides the user with an indication that the device is capturing video and enables the user to see the content being recorded and/or information about a video call (e.g., video of one or more other participants in the video call), thereby providing the user with improved visual feedback.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, non-personal information data or a bare minimum amount of personal information can be used, such as the content being requested by the device associated with a user, other available non-personal information, or publicly available information.

1.-70. (canceled)

71. A computer system configured to communicate with one or more camera sensors, the computer system comprising:
one or more processors; and
memory storing one or more programs configured to be executed by the one or more processors, the one or more programs including instructions for:
detecting a request to capture video with the one or more camera sensors of the computer system; and
in response to detecting the request to capture the video:
in accordance with a determination that the computer system is connected to a moveable mount, initiating a process to capture video with the one or more camera sensors of the computer system according to a respective subject tracking mode of operation; and
in accordance with a determination that the computer system is not connected to a moveable mount, initiating a process to capture video with the one or more camera sensors without enabling the respective subject tracking mode of operation.

72. The computer system of claim 71, the one or more programs further including instructions for:
after capturing video with the one or more camera sensors, with the computer system not connected to the moveable mount and without the respective subject tracking mode of operation enabled, receiving an indication that the computer system is connected to the moveable mount; and
in response to receiving the indication that the computer system is connected to the moveable mount, enabling the respective subject tracking mode of operation.

73. The computer system of claim 71, wherein:
capturing video with the one or more camera sensors according to the respective subject tracking mode of operation includes capturing video using a first algorithm; and
capturing video with the one or more camera sensors without enabling the respective subject tracking mode of operation includes capturing video using a second algorithm that is different from the first algorithm.

74. The computer system of claim 73, wherein a first subject and a second subject are within a field of view of the one or more camera sensors, the one or more programs further including instructions for:
while capturing video with the one or more camera sensors according to the respective subject tracking mode of operation:
in response to detecting movement of the first subject, tracking the movement of the first subject.

75. The computer system of claim 73, the one or more programs further including instructions for:
while capturing video with the one or more camera sensors according to the respective subject tracking mode of operation:
in accordance with a determination that a gaze of a first subject is directed to an item of interest, changing a field of view of the one or more camera sensors to include the item of interest.

76. The computer system of claim 73, the one or more programs further including instructions for:
while capturing video with the one or more camera sensors according to the respective subject tracking mode of operation:
in response to detecting movement of a first subject, changing a field of view of the one or more camera sensors to track the first subject without changing a zoom level of the field of view of the one or more camera sensors.

77. The computer system of claim 71, the one or more programs further including instructions for:
while capturing video with the one or more camera sensors according to the respective subject tracking mode of operation:
in accordance with a determination that a first subject has moved outside the field of view of the one or more camera sensors, changing a field of view of the one or more camera sensors based on a trajectory of the first subject.

78. The computer system of claim 77, the one or more programs further including instructions for:
while capturing video with the one or more camera sensors according to the respective subject tracking mode of operation:
in accordance with a determination that the first subject has been outside the field of view of the one or more camera sensors for a predetermined period of time, maintaining the field of view of the one or more camera sensors.

79. The computer system of claim 71, wherein the computer system includes two or more camera sensors, the one or more programs further including instructions for:
capturing video with a first camera sensor of the two or more camera sensors according to the respective subject tracking mode of operation, including tracking movement of a first subject based on video captured by the first camera sensor; and
in accordance with a determination that the first subject is outside a field of view of the first camera sensor of the two or more camera sensors and the first subject is within a field of view of a second camera sensor of the two or more camera sensors, capturing video with the second camera sensor of the two or more camera sensors according to the respective subject tracking mode of operation.

80. The computer system of claim 71, the one or more programs further including instructions for:
capturing video with the one or more camera sensors according to the respective subject tracking mode of operation, including tracking movement of a first subject in accordance with a determination that the first subject is a first person detected in a field of view of the one or more camera sensors when the respective subject tracking mode of operation is enabled.

81. The computer system of claim 71, the one or more programs further including instructions for:
capturing video with the one or more camera sensors according to the respective subject tracking mode of operation, including tracking movement of a first subject, wherein the first subject is tracked based on a detection of a face of the first subject when the respective subject tracking mode of operation is enabled.

82. The computer system of claim 71, the one or more programs further including instructions for:
capturing video with the one or more camera sensors according to the respective subject tracking mode of operation, including tracking movement of a first subject, wherein the first subject is tracked based on a detection of a body of the first subject when the respective subject tracking mode of operation is enabled.

83. The computer system of claim 71, the one or more programs further including instructions for:
capturing video with the one or more camera sensors according to the respective subject tracking mode of operation, including tracking movement of a first subject, wherein the first subject is tracked based on a detection of one or more facial features of a known subject when the respective subject tracking mode of operation is enabled.

84. The computer system of claim 71, the one or more programs further including instructions for:
capturing video with the one or more camera sensors according to the respective subject tracking mode of operation, including tracking movement of a first subject, wherein the first subject is tracked based on the first subject being a person that is closest to the center of a field of view of the one or more camera sensors when the respective subject tracking mode of operation is enabled.

85. The computer system of claim 71, the one or more programs further including instructions for:
capturing video with the one or more camera sensors according to the respective subject tracking mode of operation, including tracking movement of a first subject, wherein the first subject is tracked based on the first subject being a person that is closest to the center of the field of view of the one or more camera sensors and is looking at the one or more camera sensors when the respective subject tracking mode of operation is enabled.

86. The computer system of claim 71, wherein a first subject and a second subject are within a field of view of the one or more camera sensors, the one or more programs further including instructions for:
capturing video with the one or more camera sensors according to the respective subject tracking mode of operation, including tracking the first subject; and
after tracking the first subject, in accordance with a determination that the first subject is outside the field of view of the one or more camera sensors for a predetermined period of time, changing the field of view of the one or more camera sensors based on a position of the second subject.

87. The computer system of claim 86, wherein the field of view of the one or more camera sensors is changed based on the position associated with the second subject in accordance with a determination that the second subject is a person that is closest to the center of the field of view of the one or more camera sensors at the time of the determination that the first subject is outside the field of view of the one or more camera sensors for the predetermined period of time.

88. The computer system of claim 86, wherein the field of view of the one or more camera sensors is changed based on the position associated with the second subject in accordance with a determination that the second subject is a person that was previously identified within the field of view of the one or more camera sensors.

89. The computer system of claim 86, wherein the position associated with the second subject is a last known location of the second subject.

90. The computer system of claim 89, the one or more programs further including instructions for:
after changing the field of view of the one or more camera sensors based on a position of the second subject:
in accordance with a determination that the second subject is outside the field of view of the one or more camera sensors for a predetermined period of time, changing the field of view of the one or more camera sensors based on a position of the first subject.

91. The computer system of claim 89, the one or more programs further including instructions for:
capturing video with the one or more camera sensors according to the respective subject tracking mode of operation, including tracking a first subject; and
in accordance with a determination that the moveable mount reaches a movement limit, ceasing tracking the first subject.

92. The computer system of claim 71, the one or more programs further including instructions for:
while capturing video with the one or more camera sensors of the computer system according to the respective subject tracking mode of operation:
in accordance with a determination that one or more characteristics of movement of a respective subject satisfy a first criteria, changing a displayed field of view of the one or more camera sensors; and
in accordance with a determination that the one or more characteristics of movement of the respective subject does not satisfy the first criteria, maintaining the displayed field of view of the one or more camera sensors.

93. The computer system of claim 92, the one or more programs further including instructions for:
while capturing video with the one or more camera sensors of the computer system according to the respective subject tracking mode of operation and after changing the displayed field of view of the one or more camera sensors in accordance with a determination that one or more characteristics of movement of a respective subject satisfy the first criteria:
in accordance with a determination that one or more characteristics of movement of a respective subject satisfy a second predetermined criteria, changing the displayed field of view of the one or more camera sensors; and
in accordance with a determination that the one or more characteristics of movement of the respective subject does not satisfy the second predetermined criteria, maintaining the displayed field of view of the one or more camera sensors.

94. The computer system of claim 71, the one or more programs further including instructions for:
in accordance with a determination that the respective subject tracking mode of operation is enabled, causing output of an indication that the respective subject tracking mode of operation is enabled.

95. The computer system of claim 94, wherein causing the output of the indication that the respective subject tracking mode of operation is enabled includes:
in accordance with a determination that the respective subject tracking mode of operation is active, causing output of the indication with a first characteristic.

96. The computer system of claim 95, wherein causing the output of the indication that the respective subject tracking mode of operation is enabled includes:
in accordance with a determination that the respective subject tracking mode of operation is not active, causing output of the indication with a second characteristic that is different from the first characteristic.

97. A non-transitory computer-readable storage medium storing one or more programs configured to be executed by one or more processors of a computer system that is in communication with one or more camera sensors, the one or more programs including instructions for:
detecting a request to capture video with the one or more camera sensors of the computer system; and
in response to detecting the request to capture the video:
in accordance with a determination that the computer system is connected to a moveable mount, initiating a process to capture video with the one or more camera sensors of the computer system according to a respective subject tracking mode of operation; and
in accordance with a determination that the computer system is not connected to a moveable mount, initiating a process to capture video with the one or more camera sensors without enabling the respective subject tracking mode of operation.

98. A method, comprising:
at a computer system that is in communication with one or more camera sensors:
detecting a request to capture video with the one or more camera sensors of the computer system; and
in response to detecting the request to capture the video:
in accordance with a determination that the computer system is connected to a moveable mount, initiating a process to capture video with the one or more camera sensors of the computer system according to a respective subject tracking mode of operation; and
in accordance with a determination that the computer system is not connected to a moveable mount, initiating a process to capture video with the one or more camera sensors without enabling the respective subject tracking mode of operation.
